(19) United States
(12) Patent Application Publication
(10) Pub. No.: US 2009/0087683 A1
(43) Pub. Date: Apr. 2, 2009

(54) Reaction Method and Apparatus and Method and Apparatus for Manufacturing Chemical Substance Using the Same

(75) Inventors: Fumiko Shiraishi, Kanagawa (JP); Hideharu Nagasawa, Kanagawa (JP); Yasunori Ichikawa, Kanagawa (JP); Seiji Sugiyama, Kanagawa (JP); Koukichi Waki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/910,263

(22) PCT Filed: Mar. 28, 2006
(86) PCT No.: PCT/JP2006/307013

§ 371 Date: Sep. 29, 2007

(30) Foreign Application Priority Data
Mar. 29, 2005 (JP) 2005-094280
Mar. 29, 2005 (JP) 2005-094281

(51) Int. Cl. G11B 5/00; B01J 14/00; B01D 19/00; B01J 19/10; B01F 3/08

(52) U.S. Cl. 428/800; 422/224; 422/128; 422/189

(57) ABSTRACT

The present invention provides a reaction method for a reaction system generating gas by a reaction, comprising the steps of: providing a sealed mixing section for mixing a plurality of liquids to start a reaction and a degassing section having a gas-liquid interface for removing, from a reaction liquid, gas bubbles generated from a mixed reaction liquid, separately; and feeding the reaction liquid mixed in the mixing section to the degassing section, without being interfered by gas bubbles even in a reaction system where gas is generated by a reaction, so that it is possible to stabilize a reaction at the start of the reaction and in the progress of the reaction and stably feed liquid to a subsequent process.

### TECHNICAL FIELD

The present invention relates to a reaction method and apparatus and a method and apparatus for manufacturing a chemical substance using the same, and particularly relates to a reaction method and apparatus in a reaction system, in which gas bubbles are generated by a liquid-liquid reaction, and a method and apparatus for manufacturing a chemical substance using the same.

### BACKGROUND ART

When handling a reaction system where gas bubbles are generated by a liquid-liquid reaction, in order to stabilize a reaction at the start of the reaction and in the progress of the reaction, it is necessary to positively perform degassing both in a batch process and a continuous flow process. In a batch process, when mixing is performed with an agitator in a system where bubbles are trapped, shearing force is less likely to be applied to a continuous phase due to a volume change of bubbles. Thus, agitation efficiency decreases and uniform mixing cannot be performed. In a continuous flow process, bubbles cause an unstable flow of continuous processing, resulting in an uneven mixed field and reaction field. Moreover, the equilibrium of a reaction becomes hard to move to a reaction acceleration side and liquid is unstably fed to a subsequent process.

A method for manufacturing a chemical substance in a reaction system where gas is generated, for example, includes the manufacturing of magnetic particles contained in a magnetic layer of a magnetic recording medium. In order to manufacture magnetic particles with small size and high monodispersity, it is necessary to uniformly and efficiently mix liquids which start a reaction for forming metal fine particles. Gas (e.g., hydrogen gas) generated by a reaction has to be quickly removed so as not to interfere with mixing.

However, continuous processing is hard to perform in a reaction system where gas is generated. Actually, few prior arts of such a system are available. This is because in a continuous flow process, bubbles cause an unstable flow of continuous processing, resulting in an uneven mixed field and reaction field. Moreover, the equilibrium of a reaction becomes hard to move to a reaction acceleration side, liquid is unstably fed to a subsequent process, and the uniform quality of a manufactured chemical becomes hard to obtain.

A reaction apparatus comprising a conventional degassing function is disclosed in Japanese Patent Laid-Open No. 9-10507, in which an agitator for mixing is provided on a lower part in a reaction chamber for performing a chemical reaction and a defoaming blade is provided on an upper part in the reaction chamber. Gas bubbles floating in a reaction solution are broken by the shearing force of the defoaming blade, so that the bubbles are mechanically broken.

### DISCLOSURE OF THE INVENTION

However, in Japanese Patent Laid-Open No. 9-10507, a mixing reaction and degassing are simultaneously performed by the agitator in the reaction chamber. Since some bubbles are accumulated in the reaction chamber, the bubbles interfere with the agitator for mixing reaction solutions and agitation efficiency decreases. Because of the low agitation efficiency, mixing for starting a reaction is not uniformly performed, causing an unstable reaction at the start of the reaction and in the progress of the reaction.

As in the case of the manufacturing of magnetic particles of chemical substances, when a second mixing reaction has to be performed by adding an added solution to the reaction solution of a first mixing reaction, gas bubbles generated by the first mixing reaction have to be sufficiently removed before the second mixing reaction, otherwise fine magnetic particles with high monodispersity cannot be manufactured.

The present invention is devised in view of these circumstances. An object of the present invention is to provide a reaction method and apparatus which can evenly and efficiently perform mixing without being interfered by gas bubbles even in a reaction system where gas is generated by a reaction, so that it is possible to stabilize a reaction at the start of the reaction and in the progress of the reaction and stably feed liquid to a subsequent process.

Further, the present invention is devised in view of these circumstances and another object of the present invention is to provide a method and apparatus for manufacturing a chemical substance, by which mixing can be evenly and efficiently performed without being interfered by gas bubbles and degassing is sufficiently performed on a reaction solution before a second mixing reaction even in a reaction system where gas is generated by a first mixing reaction, so that a high-quality chemical can be manufactured.

In order to attain the objects, a first aspect of the present invention provides a reaction method for a reaction system generating gas by a reaction, comprising the steps of: providing a sealed mixing section for mixing a plurality of liquids to start a reaction and a degassing section having a gas-liquid interface for removing, from a reaction liquid, gas bubbles generated from a mixed reaction liquid, separately; and feeding the reaction liquid mixed in the mixing section to the degassing section.

According to the first aspect of present invention, the mixing section for mixing the plurality of liquids to start a reaction is separated from the degassing section having the gas-liquid interface for removing, from the reaction liquid, gas bubbles generated from the mixed reaction liquid, and the reaction liquid having been mixed in the mixing section is fed to the degassing section. Thus, it is possible to evenly and efficiently perform mixing without being interfered by gas bubbles generated by a reaction. With this configuration, a reaction can be stabilized at the start of the reaction. Gas bubbles generated with the progress of a reaction are efficiently removed from the gas-liquid interface in the degassing section, and thus a reaction in the progress of the reaction can be also stabilized. Further, continuous degassing stabilizes the flow of the reaction liquid in the degassing section, and thus liquid can be stably fed to a subsequent process.

Regarding a time period during which the reaction liquid is fed from the mixing section to the degassing section, method is preferably selected according to a handled reaction rate. For example, when a reaction rate is high and gas bubbles appear immediately after the completion of mixing, the reaction liquid is preferably fed to the degassing section immediately within 0.1 to 5 seconds. A more preferable time period is 0.1 to 3 seconds.

Further, the reaction method of the present invention may be used for batch method in which liquid fed to the mixing section is mixed in a batch manner and the whole reaction liquid having been mixed in the mixing section is fed to the degassing section at the completion of mixing. Alternatively, the reaction method may be used for continuous flow method in which a tank or the like is prepared for storing liquid and the liquid is continuously passed through the tank, the mixing section, and the degassing section in this order.

A second aspect, in the first aspect, is characterized in that mixing is instantly performed in the mixing section.

In the case of a long time period from the start of mixing to the end of mixing in the mixing section, generated gas may reduce mixing efficiency in the latter half of mixing. Instant mixing does not cause such a problem.

A third aspect, in the first or second aspect, is wherein the degassing section is a path where the gas-liquid interface is formed by a liquid part of the reaction liquid and a space for storing gas removed from the reaction liquid, and gas bubbles in the reaction liquid passing through the path are removed to the space.

According to the third aspect, the degassing section is configured as the path having the gas-liquid interface formed by the liquid part of the reaction liquid and the space for storing gas removed from the reaction liquid, so that gas bubbles generated with the progress of a reaction can be efficiently removed from the gas-liquid interface to the space. Since the degassing section is configured as the path, it is possible to obtain a long path length for degassing, thereby positively removing bubbles in the reaction liquid.

A fourth aspect, in the third aspect, is characterized in that the pressure of the space is reduced.

By reducing the pressure of the space, gas bubbles in the reaction liquid are easily removed to the space.

A fifth aspect, in the third or fourth aspect, is characterized in that the path has an upflow path and a downflow path where the reaction liquid continuously flows, and the gas-liquid interface is formed on a part where a flow is reversed from the upflow path to the downflow path.

According to the fifth aspect, the gas-liquid interface is formed on the part where the flow of the reaction liquid is reversed from the upflow path to the downflow path. Thus, bubbles having floated with the reaction liquid in the upflow path remain on the gas-liquid interface and only the reaction liquid flows down in the downflow path. Bubbles remaining on the gas-liquid interface are gradually broken and stored as gas in the space. Since the upflow path for the reaction liquid is provided in the path, it is possible to use both of the floating force of bubbles and the ascending force of the reaction liquid, thereby effectively floating bubbles.

A sixth aspect, in any one of the third to fifth aspects, is characterized in that the reaction liquid passes through the path where the upflow path and the downflow path are configured in multiple stages.

The reaction of the reaction liquid proceeds and generates gas while passing through the path. Since the upflow path and the downflow path are configured in multiple stages, degassing can be effectively performed until the reaction of the reaction liquid is completed.

A seventh aspect, in any one of the first to sixth aspects, is characterized in that the reaction liquid passing through the degassing section is heated or cooled to control a reaction temperature.

Since the reaction liquid passing through the degassing section is heated or cooled to control a reaction temperature, the reaction conditions can be fixed all the time regardless of an air temperature and an ambient temperature. Thus, an amount of generated gas can be kept regardless of an air temperature. With this configuration, it is possible to accurately perform degassing and reproduce an amount of degassing in the designed degassing device regardless of seasons and an ambient temperature, so that the shape and capacity of the device can be fixed.

An eighth aspect, in any one of the first to seventh aspects, is characterized in that ultrasonic waves are applied to the reaction liquid passing through the degassing section.

Bubbles adhering on the wall surface of the path are hard to remove. By applying ultrasonic waves to the reaction liquid passing through the degassing section to vibrate the reaction liquid, bubbles adhering on the wall surface are easily removed, so that more effective degassing can be performed.

A ninth aspect, in any one of the fifth to eighth aspects, is characterized in that the reaction liquid passing through the downflow path has a lower flow velocity than the upflow velocity of the bubbles.

Gas bubbles also appear in the reaction liquid passing through the downflow path. In the downflow path, the floating force of bubbles and the flow of the reaction liquid are opposite from each other, so that bubbles are hard to float to the gas-liquid interface. Since the flow velocity of the reaction liquid passing through the downflow path is set lower than the upflow velocity of bubbles, bubbles can be efficiently floated in the downflow path.

A tenth aspect, in any one of the first to ninth aspects, is characterized in that the degassing section is transparent.

Since the degassing section is transparent, a degassing state can be properly recognized.

In order to attain the objects, an eleventh aspect of the present invention provides a reaction apparatus for a reaction system generating gas by a reaction, comprising: a sealed mixing section for mixing a plurality of liquids to start a reaction; and a degassing section which is separated from the mixing section and has a gas-liquid interface for removing, from a reaction liquid, gas bubbles generated from the reaction liquid having been mixed in the mixing section.

The eleventh aspect is an apparatus configured according to the present invention. Mixing can be evenly performed without being interfered by gas bubbles generated by a reaction. Thus, it is possible to stabilize a reaction at the start of the reaction and in the progress of the reaction and stably feed liquid to a subsequent process.

A twelfth aspect, in the eleventh aspect, is characterized in that the mixing section is a high-pressure mixing device which supplies at least one of the plurality of liquids as a high-pressure jet flow of 1 MPa or more into a mixing chamber with a residence time of 5 seconds or less, and instantly mixes the liquid with another liquid.

The twelfth aspect is a preferable device for achieving instant mixing in the mixing section. It is preferable to use a high-pressure mixing device which supplies at least one of the plurality of liquids as a high-pressure jet flow of 1 MPa or more into the mixing chamber with a residence time of 5 seconds or less, and instantly mixes the liquid with another liquid.

A thirteenth aspect, in the eleventh or twelfth aspect, is characterized in that the degassing section is a path where the gas-liquid interface is formed by a liquid part of the reaction liquid and a space for storing gas removed from the reaction liquid, comprising: the degassing section includes a degassing container having an inlet and an outlet for the reaction liquid; a plurality of sheathing boards each of which is raised from a bottom of the degassing container and has an upper end positioned lower than the gas-liquid interface; and a baffles each of which is disposed between the sheathing boards and has an upper end positioned higher than the gas-liquid interface and a lower end separated from the bottom of the degassing container, wherein the degassing container has an upflow path and a downflow path where the reaction liquid continuously flows, and the gas-liquid interface is formed on a part where a flow is reversed from the upflow path to the downflow path in the degassing container.

The thirteenth aspect is a preferable embodiment in which the degassing section is a path having the gas-liquid interface of the reaction liquid and the space. As described above, the sheathing boards and the baffles constitute the path in the degassing container.

A fourteenth aspect, in the thirteenth aspect, is characterized in that the space is not partitioned by the baffles.

Since the space is not partitioned by the baffles, the pressure of the overall space can be equalized. In this case, the baffles may not be provided on the part corresponding to the space or communicating holes may be formed on parts of the baffles so as to correspond to the space.

A fifteenth aspect, in the thirteenth or fourteenth aspect, is characterized in that the sheathing boards become lower, one by one, from the inlet to the outlet of the degassing container.

In the path formed in the degassing container, a larger amount of gas is generated at the inlet and a smaller amount of gas is generated at the outlet from the reaction liquid. For this reason, a path length to the gas-liquid interface has to be long at the inlet of the path. By setting the sheathing boards lower one by one from the inlet to the outlet of the degassing container, a path length to the gas-liquid interface can be obtained according to an amount of generated gas, eliminating the need for an extremely long path length.

A sixteenth aspect, in any one of the thirteenth to fifteenth aspects, is characterized by comprising a pressure adjusting device for adjusting the pressure of the space.

Since the pressure of the space is adjusted by the pressure adjusting device, the pressure of the space can be adjusted such that bubbles are easily removed from the reaction liquid passing through the path.

A seventeenth aspect, in any one of the first to sixteenth aspects, is characterized in that the degassing section comprises a temperature adjusting device for heating or cooling the reaction liquid to control a reaction temperature.

Since the reaction liquid passing through the degassing section is heated or cooled to control a reaction temperature, the reaction conditions can be fixed all the time regardless of an air temperature and an ambient temperature. Thus, an amount of generated gas can be kept regardless of an air temperature. With this configuration, it is possible to accurately perform degassing and reproduce an amount of degassing in the designed degassing device regardless of seasons and an ambient temperature, so that the shape and capacity of the device can be fixed.

An eighteenth aspect, in any one of the first to seventeenth aspects, is characterized in that the degassing section comprises a ultrasonic wave applying device for applying ultrasonic waves to the reaction liquid.

Since ultrasonic waves are emitted to the reaction liquid passing through the path, degassing efficiency can be improved.

A nineteenth aspect, in any one of the thirteenth to eighteenth aspects, is characterized by comprising an agitator for forming a flow for preventing liquid from remaining in the bottom of the upflow path formed in the degassing container.

For example, when metal fine particles are generated by a reaction as in the manufacturing of magnetic particles, metal fine particles are easily settled in the bottom of the degassing container. Since the agitator for forming a flow for preventing liquid from remaining is provided in the bottom of the upflow path, fine particles are less likely to be settled.

A twentieth aspect, in any one of the thirteenth to nineteenth aspects, is characterized in that the downflow path is different in cross-sectional area from the upflow path.

For example, when the flow velocity of the reaction liquid passing through the path is set lower than that of the downflow path, bubbles appearing in the downflow path are easily floated to the gas-liquid interface.

A twenty first aspect, in any one of the thirteenth to twentieth aspects, is characterized in that surface treatment is performed on the inner surface of the degassing container, a surface of the sheathing board, and a surface of the baffle to reduce the adhesion of the gas bubbles.

Since surface treatment is performed on the inner surface of the degassing container, the surface of the sheathing board, and the surface of the baffle to disable the adhesion of the gas bubbles, bubbles are less likely to adhere and degassing can be easily performed.

A twenty second aspect, in any one of the thirteenth to twenty first aspects, is characterized in that the bottom of the degassing container is shaped like an arc where the flow of the reaction liquid is reversed from the downflow path to the upflow path.

Since the bottom of the degassing container is shaped like an arc where the flow of the reaction liquid is reversed from the downflow path to the upflow path, the reaction liquid smoothly passes through the path and fine particles are less likely to be accumulated in the bottom of the container even when fine particles are generated by a reaction as described above.

A twenty third aspect, in any one of the thirteenth to twenty second aspects, is characterized in that the reaction of the plurality of liquids is a reaction for generating magnetic particles.

In order to attain the objects, a twenty fourth aspect of the present invention provides a method of manufacturing a chemical substance generating gas in response to a reaction, comprising: a first mixing step of performing a mixing reaction on a plurality of solutions in a sealed first mixing section; a degassing step of performing degassing for gas bubbles in a degassing section having a gas-liquid interface, the gas bubbles being generated from a reaction liquid having been subjected to the mixing reaction in the first mixing step; and a second mixing step of performing a mixing reaction by adding an added solution to the reaction liquid in a second mixing section, the reaction liquid having been subjected to degassing in the degassing step, wherein the reaction liquid is fed from the first mixing step to the degassing step and then fed to the second mixing step after completion of degassing in the degassing step.

According to the twenty fourth aspect of the present invention, the sealed first mixing section of the first mixing step for the first mixing reaction is separated from the degassing section having the gas-liquid interface for removing gas bubbles from the reaction liquid, the gas bubbles being generated when a reaction is started by mixing. Further, the reaction liquid having been mixed in the first mixing step is fed to the degassing step, and thus mixing can be evenly and efficiently performed in the first mixing section without being interfered by gas bubbles generated by a reaction. Hence, a reaction can be stabilized at the start of the reaction.

Moreover, gas bubbles generated with the progress of a reaction can be efficiently removed from the gas-liquid interface in the degassing section. Hence, a reaction can be stabilized in the progress of the reaction and the flow of the reaction can be also stabilized in the degassing section. Since it is possible to stabilize an amount of liquid fed from the degassing step to the second mixing step, mixing can be performed with an accurate mixing ratio. Furthermore, mixing can be evenly and efficiently performed without being interfered by bubbles.

Regarding a time period during which the reaction liquid is fed from the first mixing section to the degassing section, method is preferably selected according to a handled reaction rate. For example, when a reaction rate is high and gas bubbles appear immediately after the completion of mixing, the reaction liquid is preferably fed to the degassing section immediately within 0.1 to 5 seconds after the completion of mixing in the first mixing section. A more preferable time period is 0.1 to 3 seconds.

Further, the manufacturing method for a chemical substance of the present invention may be used for batch method in which liquid fed to the first mixing section is mixed in a batch manner, the whole reaction liquid having been mixed in the first mixing section is fed to the degassing section and subjected to degassing at the completion of mixing, and the reaction liquid is fed to the second mixing section after degassing. Alternatively, the manufacturing method may be used for continuous flow method in which a tank or the like is prepared for storing liquid and the liquid is continuously passed through the tank, the first mixing section, the degassing section, and the second mixing section in this order.

A twenty fifth aspect, in the twenty fourth aspect, characterized by comprising mixing/degassing units in series in two or more stages, the mixing/degassing method having a combination of the first mixing step and the degassing step.

In some reaction systems, the mixing/degassing steps may be provided in series in two or more stages, the mixing/degassing unit having a combination of the first mixing step and the degassing step.

A twenty sixth aspect, in the twenty fourth or twenty fifth aspect, is characterized in that in the first mixing step, a first solution containing two or more kinds of metal ions selected from groups 8, 9, and 10 of the periodic table and a second solution containing a reducer are mixed; in the second mixing step, a third solution containing one or more kinds of metal ions selected from groups 11, 12, 13, 14, and 15 of the periodic table is added to and mixed with a reaction liquid having been mixed in the first mixing step; and magnetic particles are manufactured as the chemical substance.

The twenty sixth aspect defines a preferable solution for manufacturing magnetic particles as a chemical substance and can effectively enhance the effect of the present invention, thereby manufacturing fine magnetic particles with high monodispersity.

A twenty seventh aspect, in any one of the twenty fourth to twenty sixth aspects, is characterized in that of the first mixing step and the second mixing step, mixing is instantly performed at least in the first mixing step.

In the case of a long time period from the start of mixing to the end of mixing in the first mixing section, generated gas may reduce mixing efficiency in the latter half of mixing. Instant mixing does not cause such a problem.

A twenty eighth aspect, in the twenty fourth to twenty seventh aspects, is characterized in that the degassing section is a path where the gas-liquid interface is formed by a liquid part of the reaction liquid and a space for storing gas removed from the reaction liquid, and gas bubbles in the reaction liquid passing through the path are removed to the space.

According to the twenty eighth aspect, the degassing section is configured as the path having the gas-liquid interface formed by the liquid part of the reaction liquid and the space for storing gas removed from the reaction liquid, so that gas bubbles generated with the progress of a reaction can be efficiently and continuously removed from the gas-liquid interface. Since the degassing section is configured as the path, it is possible to obtain a long path length for degassing, thereby positively performing degassing.

A twenty ninth aspect, in the twenty eighth aspect, is characterized in that the pressure of the space is reduced.

Since the pressure of the space is reduced, gas bubbles in the reaction liquid are easily removed to the space.

A thirtieth aspect, in the twenty eighth or twenty ninth aspect, is characterized in that the path has an upflow path and a downflow path where the reaction liquid continuously flows, and the gas-liquid interface is formed on a part where a flow is reversed from the upflow path to the downflow path.

According to the thirtieth aspect, the gas-liquid interface is formed on the part where the flow of the reaction liquid is reversed from the upflow path to the downflow path. Thus, bubbles having floated with the reaction liquid in the upflow path remain on the gas-liquid interface and only the reaction liquid moves down in the downflow path. Bubbles remaining on the gas-liquid interface are gradually broken and stored as gas in the space. Since the upflow path for the reaction liquid is provided in the path, it is possible to use both of the floating force of bubbles and the ascending force of the reaction liquid, thereby effectively floating bubbles.

A thirty first aspect, in any one of the twenty eighth to thirtieth aspects, is characterized in that the reaction liquid passing through the degassing section is heated or cooled to control a reaction temperature.

Since the reaction liquid passing through the degassing section is heated or cooled to control a reaction temperature, the reaction conditions can be fixed all the time regardless of an air temperature and an ambient temperature. Thus, an amount of generated gas can be kept regardless of an air temperature. With this configuration, it is possible to accurately perform degassing and reproduce an amount of degassing in the designed degassing device regardless of seasons and an ambient temperature, so that the shape and capacity of the device can be fixed.

A thirty second aspect, in any one of the twenty eighth to thirty first aspects, is characterized in that ultrasonic waves are applied to the reaction liquid passing through the degassing section.

Bubbles adhering on the wall surface of the path are hard to remove. By applying ultrasonic waves to the reaction liquid passing through the degassing section to vibrate the reaction liquid, bubbles adhering on the wall surface are easily removed, so that more effective degassing can be performed.

A thirty third aspect, in any one of the twenty eighth to thirty second aspects, is characterized in that the reaction liquid passing through the downflow path has a lower flow velocity than the upflow velocity of the bubbles.

Gas bubbles also appear in the reaction liquid passing through the downflow path. In the downflow path, the floating force of bubbles and the flow of the reaction liquid are opposite from each other, so that bubbles are hard to float to the gas-liquid interface. Since the flow velocity of the reaction liquid passing through the downflow path is set lower than the upflow velocity of bubbles, bubbles can be efficiently floated in the downflow path.

A thirty fourth aspect, in any one of the twenty fourth to thirty third aspects, is characterized in that the degassing section is transparent.

Since the degassing section is transparent, a degassing state can be properly recognized.

In order to attain the objects, a thirty fifth aspect of the present invention provides a manufacturing apparatus for a chemical substance generating gas in response to a reaction, the unit comprising: a sealed first mixing section performing a mixing reaction on a plurality of solutions; a second mixing section performing a mixing reaction by adding an additive solution to a reaction liquid having been mixed in the first mixing section; and a degassing section having a gas-liquid interface for removing, from the reaction liquid, gas bubbles generated from the reaction liquid having been subjected to the mixing reaction in the first mixing section, which is provided between the first mixing section and the second mixing section.

The thirty fifth aspect is an apparatus configured according to the present invention. Mixing can be evenly performed in the first mixing section without being interfered by gas bubbles generated by a reaction. Thus, it is possible to stabilize a reaction at the start of the reaction and in the progress of the reaction. Gas bubbles generated with the progress of a reaction are efficiently removed from the gas-liquid interface in the degassing section, and thus a reaction in the progress of the reaction can be also stabilized. Further, continuous degassing stabilizes the flow of the reaction liquid in the degassing section, and thus liquid can be stably fed also to the second mixing section for performing a second mixing reaction. With this configuration, mixing can be evenly and efficiently performed in the second mixing section without being interfered by bubbles.

A thirty sixth aspect, in the thirty fifth aspect, is characterized in that of the first mixing section and the second mixing section, at least the first mixing section is a high-pressure mixing device which supplies at least one of the plurality of liquids as a high-pressure jet flow of 1 MPa or more into a mixing chamber with a residence time of 5 seconds or less, and instantly mixes the liquid with another liquid.

Of the first mixing section and the second mixing section, at least the first mixing section is a high-pressure mixing device which supplies at least one of the plurality of liquids as a high-pressure jet flow of 1 MPa or more into a mixing chamber with a residence time of 5 seconds or less, and instantly mixes the liquid with another liquid. Thus, mixing can be instantly performed in the first mixing section.

A thirty seventh aspect, in the thirty fifth or thirty sixth aspect, is characterized in that the degassing section is a path where the gas-liquid interface is formed by a liquid part of the reaction liquid and a space for storing gas removed from the reaction liquid, wherein the degassing section comprises: a degassing container having an inlet and an outlet for the reaction liquid; a plurality of sheathing boards each of which is raised from a bottom of the degassing container and has an upper end positioned lower than the gas-liquid interface; and a baffles each of which is disposed between the sheathing boards and has an upper end positioned higher than the gas-liquid interface and a lower end separated from the bottom of the degassing chamber, wherein the degassing container has an upflow path and a downflow path where the reaction liquid continuously flows, and the gas-liquid interface is formed on a part where a flow is reversed from the upflow path to the downflow path in the degassing chamber.

The thirty seventh aspect is a preferable embodiment in which the degassing section is a path having the gas-liquid interface of the reaction liquid and the space. As described above, the sheathing boards and the baffles constitute the path in the degassing container.

A thirty eighth aspect, in the thirty seventh aspect, is characterized in that the space is not partitioned by the baffles.

Since the space is not partitioned by the baffles, the pressure of the overall space can be equalized. In this case, the baffles may not be provided on the part corresponding to the space or communicating holes may be formed on parts of the sheathing boards so as to correspond to the space.

A thirty ninth aspect, in the thirty seventh or thirty eighth aspect, is characterized in that the sheathing boards become lower, one by one, from the inlet to the outlet of the degassing container.

In the path formed in the degassing container, a larger amount of gas is generated at the inlet and a smaller amount of gas is generated at the outlet from the reaction liquid. For this reason, a path length to the gas-liquid interface has to be long at the inlet of the path. By setting the sheathing boards lower one by one from the inlet to the outlet of the degassing container, a path length to the gas-liquid interface can be obtained according to an amount of generated gas, eliminating the need for an extremely long path length.

A fortieth aspect, in any one of the thirty fifth to thirty ninth aspects, is characterized by comprising a pressure adjusting device for adjusting a pressure of the space.

Since the pressure of the space is adjusted by the pressure adjusting device, the pressure of the space can be adjusted such that bubbles are easily removed from the reaction liquid passing through the path.

A forty first aspect, in any one of the thirty fifth to fortieth aspects, is characterized in that the degassing section comprises a temperature adjusting device for heating or cooling the reaction liquid to control a reaction temperature.

Since the reaction liquid passing through the degassing section is heated or cooled to control a reaction temperature, the reaction conditions can be fixed all the time regardless of an air temperature and an ambient temperature. Thus, an amount of generated gas can be kept regardless of an air temperature. With this configuration, it is possible to accurately perform degassing and reproduce an amount of degassing in the designed degassing device regardless of seasons and an ambient temperature, so that the shape and capacity of the device can be fixed.

A forty second aspect, in any one of the thirty fifth to forty first aspects, is characterized in that the degassing section comprises an ultrasonic wave applying device for applying ultrasonic waves to the reaction liquid.

Since ultrasonic waves are emitted to the reaction liquid passing through the path, degassing efficiency can be improved.

A forty third aspect, in any one of the thirty seventh to fort second aspects, is characterized by comprising an agitator for forming a flow for preventing liquid from remaining in the bottom of the upflow path formed in the degassing container.

For example, when metal fine particles are generated by a reaction as in the manufacturing of magnetic particles, metal fine particles are easily settled in the bottom of the degassing container. Since the agitator for forming a flow for preventing liquid from remaining is provided in the bottom of the upflow path, fine particles are less likely to be settled.

A forty forth aspect, in any one of the thirty seventh to forty third aspects, is characterized in that the downflow path is different in cross-sectional area from the upflow path.

For example, when the flow velocity of the reaction liquid passing through the path is set lower than that of the downflow path, bubbles appearing in the downflow path are easily floated to the gas-liquid interface.

A forty fifth aspect, in any one of the thirty seventh to forty fourth aspects, is characterized in that surface treatment is performed on the inner surface of the degassing container, a surface of the sheathing board, and a surface of the baffle to reduce the adhesion of the gas bubbles.

Since surface treatment is performed on the inner surface of the degassing container, the surface of the sheathing board, and the surface of the baffle to disable the adhesion of the gas bubbles, bubbles are less likely to adhere and degassing can be easily performed.

A forty sixth aspect, in any one of the thirty seventh to forty fifth aspects, is characterized in that the bottom of the degassing container is shaped like an arc where the flow of the reaction liquid is reversed from the downflow path to the upflow path.

The bottom of the degassing container is shaped like an arc where the flow of the reaction liquid is reversed from the downflow path to the upflow path, the reaction liquid smoothly passes through the path and fine particles are less likely to be accumulated in the bottom of the container even when fine particles are generated by a reaction as described above.

Forty seventh and forty eighth aspects are magnetic particles manufactured by the method and apparatus for manufacturing a chemical substance. A forty ninth aspect is a magnetic recording medium containing the magnetic particles in the magnetic layer.

As described above, according to the reaction method and apparatus of the present invention, mixing is performed evenly and efficiently without being interfered by gas bubbles generated by a reaction. Thus, it is possible to stabilize a reaction at the start of the reaction and in the progress of the reaction and stably feed liquid to a subsequent process.

According to the method and apparatus for manufacturing a chemical substance, mixing can be evenly and efficiently performed without being interfered by gas bubbles and degassing is sufficiently performed in a reaction liquid before a second mixing reaction even in a reaction system where gas is generated by a first mixing reaction, so that a high-quality chemical can be manufactured. Therefore, the present invention is effective for, for example, the manufacturing of magnetic particles contained in the magnetic layer of a magnetic recording medium.

### BRIEF DESCRIPTION OF THE DRAWINGS

FIG. 1 is a conceptual diagram showing an apparatus for sequentially manufacturing metal fine particles in two kinds of solutions by using an reaction apparatus of the present invention according to Embodiment 1 of the present invention;

FIG. 2 is a sectional view showing a mixing device of high-pressure mixing method of one-jet type in the reaction apparatus of the present invention;

FIG. 3 is an explanation drawing for explaining a mixing theory of high-pressure mixing method of one-jet type;

FIG. 4A is an explanatory drawing for explaining the shape of a first nozzle of the mixing device of high-pressure mixing method of one-jet type;

FIG. 4B is an explanatory drawing for explaining the shape of the first nozzle of the mixing device of high-pressure mixing method of one-jet type;

FIG. 4C is an explanatory drawing for explaining the shape of the first nozzle of the mixing device of high-pressure mixing method of one-jet type;

FIG. 5A is an explanatory drawing for explaining another shape of the first nozzle;

FIG. 5B is an explanatory drawing for explaining another shape of the first nozzle;

FIG. 5C is an explanatory drawing for explaining another shape of the first nozzle;

FIG. 6A is an explanatory drawing for explaining still another shape of the first nozzle;

FIG. 6B is an explanatory drawing for explaining still another shape of the first nozzle;

FIG. 6C is an explanatory drawing for explaining still another shape of the first nozzle;

FIG. 7A is an explanatory drawing for explaining another shape of the first nozzle;

FIG. 7B is an explanatory drawing for explaining another shape of the first nozzle;

FIG. 7C is an explanatory drawing for explaining another shape of the first nozzle;

FIG. 8 is a cross-sectional drawing showing a mixing device of high-pressure mixing method of T-type;

FIG. 9 is a cross-sectional drawing showing a mixing device of high-pressure mixing method of Y-type;

FIG. 10 is a cross-sectional drawing showing a mixing device of high-pressure mixing method of opposed two-jet type;

FIG. 11 is an explanation drawing for explaining a mixing theory of high-pressure mixing method of opposed two-jet type;

FIG. 12 is a perspective view showing a degassing device of vertically meandering flow method in the reaction apparatus of the present invention;

FIG. 13 is a cross-sectional view showing the concept of the degassing device of vertically meandering flow method;

FIG. 14 is a cross-sectional view showing an embodiment in which an agitator is provided in the bottom of the degassing device of vertically meandering method;

FIG. 15 is a cross-sectional view showing that the widths of the upflow path and the downflow path of the degassing device of vertically meandering method are changed;

FIG. 16 is an exploded view showing the degassing device of vertically meandering method as a unit;

FIG. 17 is a cross-sectional view showing the concept of a degassing device of gas transmission method; and

FIG. 18 is a conceptual diagram showing an apparatus for sequentially manufacturing metal fine particles in four kinds of solutions by using a manufacturing apparatus for a chemical substance of the present invention according to Embodiment 2 of the present invention.

### DESCRIPTION OF SYMBOLS

10 . . . reaction apparatus, 12 . . . mixing device, 14 . . . degassing device, 16,18 . . . preparation tank, 20 . . . heating jacket, 22,24 . . . supply pipe, 26,28 . . . supply pump, 30,32 . . . pipe, 34 . . . product tank, 36 . . . heating/cooling jacket, 38 . . . mixing chamber, 40 . . . mixer, 42 . . . first conduit, 44 . . . discharge pipe, 46 . . . second conduit, 48 . . . first orifice, 50 . . . second orifice, 52 . . . first nozzle, 54 . . . second nozzle, 56 . . . jacket, 58 . . . orifice member, 60 . . . third orifice, 62 . . . first addition pipe, 64 . . . mixed field, 66 . . . second addition pipe, 68 . . . discharge pipe, 70 . . . jacket, 80 . . . liquid part, 82 . . . space, 84 . . . gas-liquid interface, 86 . . . path, 86A . . . upflow path, 86B . . . downflow path, 88 . . . degassing container, 90 . . . sheathing board, 92 . . . baffle, 92A . . . communicating hole, 94 . . . inflow pipe, 96 . . . outflow pipe, 98 . . . bubble, 100 . . . agitator, 102 . . . pressure adjusting device, 106 . . . pressure sensor, 108 . . . valve, 110 . . . gas vent pipe, 112 . . . decompressing device, 114 . . . valve, 116 . . . gas supply pipe, 118 . . . control unit, 120 . . . temperature adjusting device, 122 . . . ultrasonic generator, 124 . . . inlet unit, 126 . . . intermediate unit, 128 . . . outlet unit, 130, 134, 140 . . . box, 132, 138 . . . outlet duct, 136, 142 . . . inlet duct, 150 . . . degassing pipe, 200 . . . production unit for a chemical substance, 212 . . . first mixing device, 213 . . . second mixing device, 214 . . . degassing device, 215 . . . third preparation tank, 216 . . . . first preparation tank, 218 . . . second preparation tank, 220 . . . . heating jacket, L1 . . . first solution, L2 . . . second solution, L3 . . . third solution, L4 . . . fourth solution, LM . . . reaction liquid

### BEST MODE FOR CARRYING OUT THE INVENTION

Referring to the accompanying drawings, the following will describe preferred embodiments of a reaction method and apparatus and a method and apparatus for manufacturing a chemical substance using the same according to the present invention.

### Embodiment 1

The reaction method and apparatus of the present invention will be discussed in Embodiment 1 of the present invention.

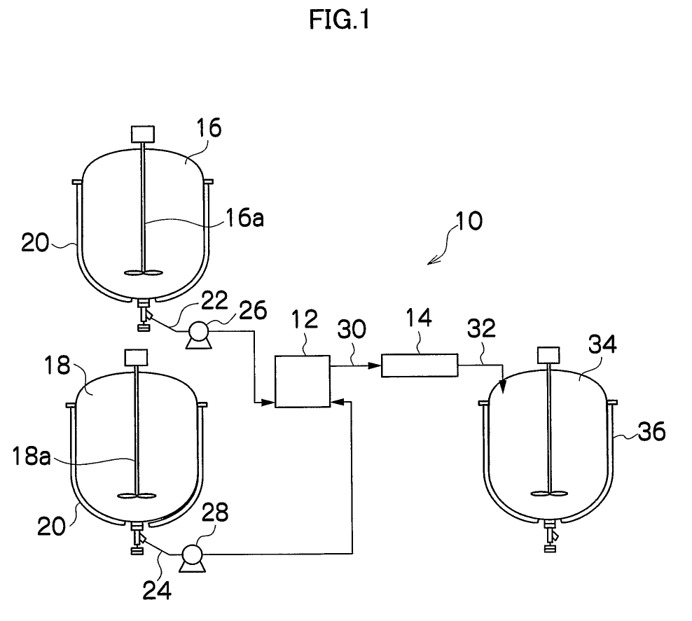

FIG. 1 is an overall structural diagram showing the reaction apparatus of the present invention and an example of continuous flow method. A reaction apparatus 10 of the present invention is applicable to any reaction system as long as gas is continuously generated with the progress of a reaction by liquid-phase reaction method (liquid-liquid reaction). The present embodiment will discuss an example of continuous manufacturing of metal fine particles included in the magnetic layer of a magnetic recording medium. Further, in Embodiment 1, two solutions of a solution L1 and a solution L2 are caused to react to manufacture metal fine particles. The solutions are obtained by dissolving, into a solvent, solutes for generating metal fine particles.

As shown in FIG. 1, the reaction apparatus 10 is mainly constituted of a sealed mixing device 12 for mixing two or more solutions to start a reaction, and a degassing device 14 which is separated as a device from the mixing device 12 and has a gas-liquid interface for removing, from a reaction liquid LM, gas bubbles generated from the reaction liquid LM having been mixed by the mixing device 12.

As the first solution L1 for manufacturing metal fine particles, a reducer solution is preferably used. As the second solution L2, a solution containing two or more kinds of metal ions selected from groups 8, 9, and 10 of the periodic table is preferably used. Metal ions of Fe, Pt, Co, Ni, and Pd are preferable.

Among liquid-phase reaction methods, reversed micelle method is preferable by which the size of a metal fine particle can be easily controlled. It is preferable to prepare the first and second solutions L1 and L2 as reversed micelle solutions by using a water-insoluble organic solvent containing a surface-active agent. The used surface-active agent is an oil-soluble surface-active agent. To be specific, a sulfonate surface-active agent (e.g., aerosol OT, Wako Pure Chemical Industries, Ltd.), a quaternary ammonium salt surface-active agent (e.g., cetyl trimethyl ammonium bromide), an ether surface-active agent (e.g., pentaethylene glycol dodecyl ether), and so on are available. As the water-insoluble organic solvent for dissolving a surface-active agent, alkane, ether, alcohol, and so on are available. Alkanes with carbon numbers 7 to 12 are preferable. To be specific, heptane, octane, isooctane, nonane, decane, undecane, dodecane, and so on are preferable. Ethers including diethyl ether, dipropyl ether, and dibutyl ether are preferable. Alcohols including ethoxyethanol and ethoxypropanol are preferable. A reducer in the reducer solution may be a single compound of alcohols, polyalcohols, H2, HCHO, S2 O6 2-, BH4-, N2H5+, H2 PO3-, and so on. Two or more kinds of compounds are preferable.

The first solution L1 and the second solution L2 are separately prepared in a first preparation tank 16 and a second preparation tank 18 which are disposed near the mixing device 12. In the first preparation tank 16, a water-insoluble organic solvent containing a surface-active agent and a reducer solution are mixed by an agitator 16a to prepare the reversed micelle solution of the first solution L1. In the second preparation tank 18, a water-insoluble organic solvent containing a surface-active agent and a metallic salt solution containing two or more kinds of metal ions selected from groups 8, 9, and 10 of the periodic table are mixed by an agitator 18a to prepare the reversed micelle solution of the second solution L2. Further, a heating jacket 20 is provided around each of the first preparation tank 16 and the second preparation tank 18 to heat the tanks to a proper temperature for an initial reaction.

The first and second solutions L1 and L2 having been prepared by the first and second preparation tanks 16 and 18 are supplied by supply pumps 26 and 28 to the mixing device 12 through supply pipes 22 and 24, respectively. The two solutions L1 and L2 are instantly mixed in the mixing device 12, discharged therefrom, passed through a pipe 30, and fed to the degassing device 14. A reaction is started by the mixing device 12 configured thus and gas is continuously generated with the progress of the reaction. The reaction solution LM having started its reaction in the mixing device 12 continues to react in the degassing device 14, and degassing is efficiently performed in a continuous manner. After a certain period of time, the reaction solution LM in the degassing device 14 is fed to a product tank 34 through a pipe 32. A heating/cooling jacket 36 is provided around the product tank 34 and liquid is heated or cooled when necessary.

In a reaction system where gas is generated by a chemical reaction, it is significant how the first and second solutions L1 and L2 are efficiently and evenly mixed without being interfered by generated gas and how degassing is efficiently performed for gas generated continuously with the progress of a reaction.

According to the present invention, the sealed mixing device 12 for mixing the plurality of solutions L1 and L2 to start a reaction is separated from the degassing device 14 having a gas-liquid interface for removing, from the reaction liquid LM, gas bubbles generated when the reaction is started by mixing, and the reaction liquid LM having been mixed in the mixing device 12 is fed to the degassing device 14. Thus, it is possible to evenly and efficiently mix the solutions in the mixing device 12 without being interfered by gas bubbles generated by a reaction. With this configuration, mixing efficiency can be increased, and thus it is possible to eliminate an unreacted substance, increase the yield of metal fine particles, and stabilize a reaction at the start of the reaction. Gas bubbles generated with the progress of a reaction are efficiently removed in a continuous manner in the degassing device 14, and thus the reaction in the progress can be also stabilized. Further, continuous degassing stabilizes the flow of the reaction liquid LM in the degassing device 14, and thus liquid can be stably fed to a subsequent process.

Either of batch method and flow method may be used for the reaction apparatus 10 of the present invention. It is preferable to select one of the methods according to a handled reaction rate. For example, when a reaction rate is high and gas bubbles appear immediately after the completion of mixing, a time period from the end of mixing to the start of degassing is preferably minimized by directly connecting the mixing device 12 and the degassing device 14. Moreover, in the case of a high reaction rate, it is preferable to directly connect the mixing device 12 and the degassing device 14 and use flow method for the mixing device 12 and the degassing device 14. A time period from the end of mixing in the mixing device 12 to the start of degassing in the degassing device is preferably about 0.1 to 5 seconds. A more preferable time period is about 0.1 to 3 seconds.

The following will discuss preferred embodiments of the mixing device 12 and the degassing device 14 according to the present invention.

### (A) Mixing Device

It is preferable that the mixing device 12 instantly mixes solutions and quickly discharges the mixed reaction liquid LM. For example, high-pressure mixing method is preferable. The following is three kinds of high-pressure mixing methods of one-jet type, T-shape type, Y-shape type, and opposed two-jet type. Any mixing method other than the high-pressure mixing method is applicable as long as solutions can be instantly mixed. For example, a static mixer or the like can be used.

### a) One-Jet Type

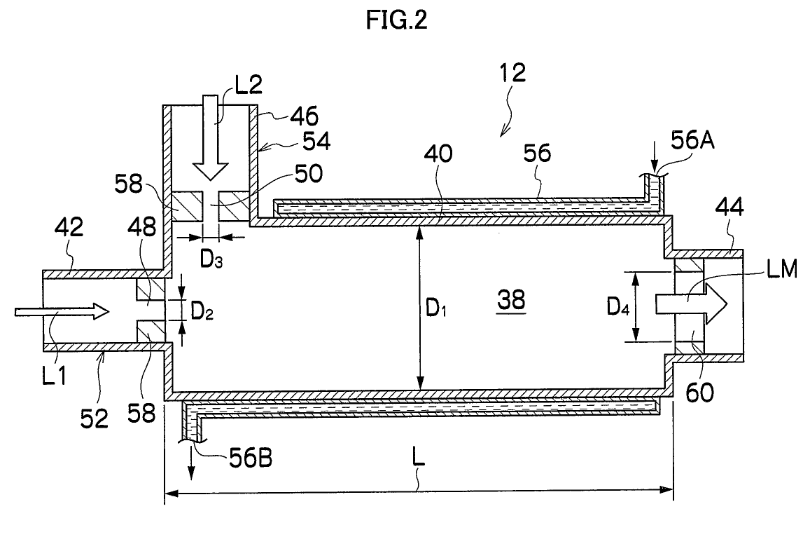

FIG. 2 is a sectional view showing the concept of the mixing device 12 of one-jet type.

As shown in FIG. 2, in the mixing device 12, a first conduit 42 is connected to the opening of one end of a mixer 40 in which a cylindrical mixing chamber 38 (mixed field) is formed to mix the first and second solutions L1 and L2 and cause the solutions to react. The first conduit 42 feeds the first solution L1 to the mixing chamber 38. Further, a discharge pipe 44 is connected to the opening of the other end of the mixer 40. The discharge pipe 44 discharges the reaction liquid LM which has been mixed and caused to react in the mixing chamber 38. Moreover, a second conduit 46 for feeding the second solution L2 to the mixing chamber 38 is connected near the outlet of the first conduit 42 on a side of the mixer 40. In the ends of the first conduit 42 and the second conduit 46, a first orifice 48 and a second orifice 50 are formed, so that a first nozzle 52 and a second nozzle 54 are formed in the first conduit 42 and the second conduit 46 to discharge turbulent liquid. In FIG. 2, the first solution L1 is fed from the first conduit 42 and the second solution L2 is fed from the second conduit 46. The solutions may be reversed. The discharge pipe 44 may be connected to a side of the mixer 40 as long as being disposed near the other end of the mixer 40.

A jacket 56 fed with a heating medium such as water and oil having a relatively large thermal capacity is wound around the mixer 40. A heating medium inlet 56A and a heating medium output 56B of the jacket are connected to a heating medium supply device (not shown). A mixing reaction temperature is preferably set at a predetermined temperature suitable for an initial reaction according to the kinds of the first and second solutions L1 and L2.

In the case where the first solutions L1 are prepared as many as two or more kinds of metal atoms and the plurality of solutions are mixed with the second solution L2, one of the solutions is preferably set as a high-pressure jet flow of 1 MPa or more. Thus, two or more nozzles for discharging the plurality of first solutions L1 may be provided on a side of the mixer 40. Alternatively, the plurality of first solutions L1 may be sequentially discharged from one nozzle. Therefore, one nozzle is basically provided for a straight high-pressure jet flow. Two or more nozzles may be provided for flows intersecting the straight flow.

When the first and second orifices 48 and 50 are formed by boring on orifice members 58 shaped like blocks, methods including microcutting, microgriding, blasting, microelectrodischarge machining, LIGA, laser machining, and SPM machining are preferably used as well-known methods for precisely boring discharge holes of about 100 μm on the orifice members 58 such as metal, ceramics, and glass.

The material of the orifice member 58 preferably has a high hardness close to that of diamond with high machinability. Therefore, except for diamond, a material obtained by curing such as quenching, nitriding, and sintering on various metals and metal alloys is preferably used. Ceramics having a high hardness and higher machinability than diamond are also preferable. In the present embodiment, the tapered structures of the first and second nozzles 52 and 54 are orifices. Other methods may be used as long as turbulent liquid is discharged.

The first conduit 42 and the second conduit 46 comprise a pressurizing device (not shown). The first solution L1 and the second solution L2 are pressurized and supplied into the first and second nozzles 52 and 54. The pressure of the solution discharged from the second nozzle 54 to the mixing chamber 38 is set lower than that of a high-pressure jet flow discharged from the first nozzle 52 to the mixing chamber 38. Various devices are known and may be used as the pressurizing device for applying a high pressure on liquid. A reciprocating pump such as a plunger pump and a booster pump is preferable because such a pump is inexpensive and relatively easy to obtain. Some rotary pumps for generating a high pressure may be used, though such pumps cannot generate a pressure as high as a reciprocating pump.

The first solution L1 is discharged from the first nozzle 52 into the mixing chamber 38 as a high-pressure jet flow of 1 MPa or more and a turbulent flow having a Reynolds number of 10000 or more. The second solution L2 having a pressure lower than that of the first solution L1 is discharged from the second nozzle 54 into the mixing chamber 38 as a flow almost intersecting the first solution L1. In this case, the second solution L2 does not have to perfectly intersect the first solution L1 at 90° as long as a mainly component is an intersecting velocity vector component. With this configuration, the first solution L1 and the second solution L2 are mixed instantly and efficiently under proper mixing temperature conditions, and the reacted reaction liquid LM is immediately discharged from the discharge pipe 44. In this case, a residence time in the mixing chamber 38 is preferably set at 5 seconds or less. Consequently, metal fine particles can be formed with a small size and high monodispersity.

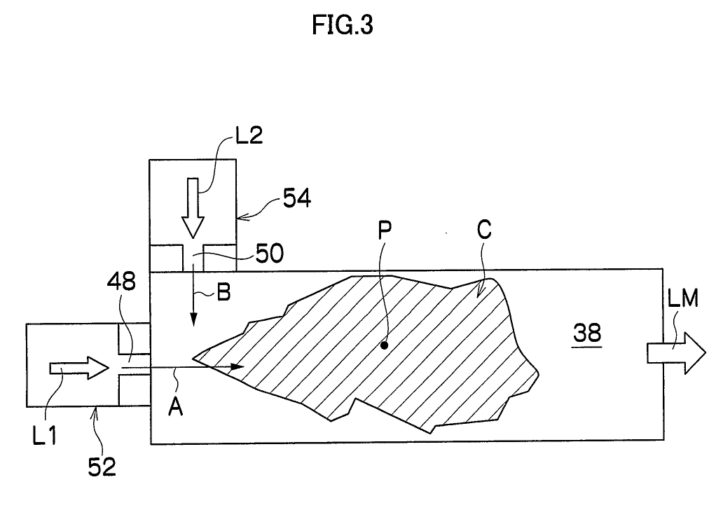

As schematically shown in FIG. 3, in such a mixing reaction, the second solution L2 discharged in a direction almost intersecting the first solution L1 is entrained in the first solution L1 of a fast and turbulent high-pressure jet flow, so that mixing efficiency can be achieved with high performance using high eddy viscosity obtained by mixing the first solution L1 and the second solution L2. The above described mixing chamber 38 in the mixing device 12, the first and second nozzles 52 and 54, and the discharge pipe 44 are formed in accordance with the following relationship:

It is necessary to form eddy viscosity in the mixing chamber 38. A diameter D1 of the mixing chamber 38 is larger than an orifice diameter D2 of the first nozzle 52 and an orifice diameter D3 of the second nozzle 54. Particularly the eddy viscosity of the first solution L1, which is straight flow A, is important for higher mixing efficiency. The dimensional ratio of the diameter D1 of the mixing chamber 38 to the orifice diameter D2 of the first nozzle 52 is preferably set at 1.1 to 50. A more preferable ratio is 1.1 to 20. In order to easily entrain the second solution L2, which acts as flow B intersecting the straight flow A, into the solution L1 acting as the straight flow A, it is preferable to set the pressure of the intersecting flow B lower than that of the straight flow A and set the discharge flow velocity of the intersecting flow B at or lower than that of the straight flow A. To be specific, the flow velocity ratio of the discharge flow velocity of the straight flow A to that of the intersecting flow B is 0.05 to 0.4. A more preferable ratio is 0.1 to 0.3.

Further, it is necessary to discharge the intersecting flow B into the mixing chamber 38 on a position before eddy viscosity C is maximized. The eddy viscosity C is formed by discharging the straight flow A from the small-diameter first nozzle 52 to the large-diameter mixing chamber 38. It is necessary to dispose the second nozzle 54 between the first nozzle 52 and a position where the eddy viscosity C is maximized. Therefore, it is necessary to locate the position where the eddy viscosity C is maximized. The position where the eddy viscosity C is maximized in the mixing chamber 38 can be recognized by performing a simulation beforehand using RFLOW, which is numerical analysis software of Rflow Co., Ltd. RFLOW is well known as flow analysis software commercially available in Japan. In this case, as shown in FIG. 3, the eddy viscosity C is maximized not on a point but over an area. Thus, it is assumed that the eddy viscosity C is maximized on a point P disposed almost at the center of the eddy viscosity C. Therefore, it is preferable to position the second nozzle 54 before the point P. More preferably, the second nozzle 54 is positioned so as to discharge the intersecting flow B at the beginning of the formation of the eddy viscosity C.

According to an analysis of the numerical analysis software, the central point P of the area where the eddy viscosity C appears relates to the flow velocity of the straight flow A. The point P almost corresponds to a position where the maximum flow velocity of the straight flow A (normally a flow velocity at the first nozzle) is reduced to one tenth. Therefore, the position where the maximum flow velocity of the direct flow A is reduced to one tenth is calculated and the second nozzle 54 is positioned so as to discharge the intersecting flow B before the point, thereby eliminating the need for calculating the point P.

Further, it is necessary to secure a length L (FIG. 2) of the mixing chamber 38 to form the maximum eddy viscosity C in the mixing chamber 38. However, when the length L is too long, the reaction liquid LM is likely to build up or flow backward in the mixing chamber 38, and thus the size reduction and monodispersity of metal fine particles are adversely affected. Thus, the length L of the mixing chamber 38 is preferably two to five times longer than a distance from the first nozzle 52 to the point P where the eddy viscosity C is maximized. More preferably, the length L is two to three times longer than the distance.

When liquid is discharged from the small-diameter first nozzle 52 and second nozzle 54 into the large-diameter mixing chamber 38 with a high flow velocity, cavitation is likely to occur. Such cavitation forms a gas-liquid interface in the mixing chamber 38 and mixing efficiency is reduced. Therefore, in order to increase mixing efficiency using the eddy viscosity C, it is necessary to prevent the formation of a gas-liquid interface in the mixing chamber 38. Hence, as shown in FIG. 2, it is necessary to reduce a diameter D4 of the discharge pipe 44 in a third orifice 60 to a diameter smaller than the diameter D1 of the mixing chamber 38 and mix solutions with a higher pressure in the mixing chamber 38. Thus, it is possible to eliminate cavitation, further improving mixing efficiency. Since residence time is minimized in a part not contributing to mixing in the discharge pipe 44, the outlet in the mixing chamber 38 is reduced and the internal diameter of the discharge pipe 44 is minimized and connected to the pipe 30. The internal diameter of the discharge pipe 44 is at least smaller than the diameter D1 of the mixing chamber 38. In this way, a distance between the mixing device 12 and the degassing device 14 is shortened, so that gas generated by a reaction in the mixing device 12 is immediately removed in the degassing device 14 without building up in the discharge pipe 44 or the pipe 30.

The shape of flow discharged from the first nozzle 52 to the mixing chamber 38 is restricted by the first orifice 48 provided in the first nozzle 52. The shape of discharged flow affects mixing performance. Therefore, the first orifices 48 forming a filar flow, a conical flow, a slit-like flow, and a fan-shaped flow are preferably used according to the purpose of a mixing reaction. For example, in the case of a reaction with an extremely high reaction rate on the order of milliseconds, it is necessary to discharge the straight flow A and the intersecting flow B to instantly maximize the eddy viscosity C within the narrowest range. Thus, it is preferable to use the first orifice 48 forming a filar flow. In the case of a reaction with a relatively low reaction rate, it is better to discharge the straight flow A and the intersecting flow B to maximize the eddy viscosity C over the widest range and increase an entrained interfacial area formed by the straight flow A. In this case, it is preferable to use the first orifice 48 forming a flow like a thin film. In the case of an intermediate reaction rate between the extremely high reaction rate on the order of milliseconds and the relatively low reaction rate, it is preferable to use the first orifice 48 forming a conical flow.

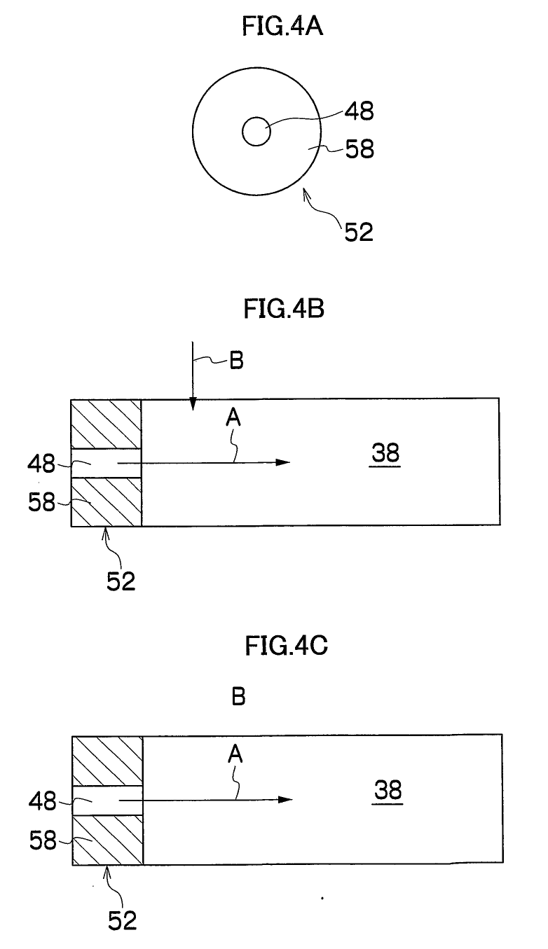

FIGS. 4A to 7C illustrate the first orifices 48 forming a filar flow, a conical flow, a slit-like flow, and a fan-shaped flow. FIGS. 4A, 5A, 6A, and 7A are viewed from the ends of orifices. FIGS. 4B, 5B, 6B, and 7B are longitudinal sectional views showing the orifices. FIGS. 4C, 5C, 6C, and 7C are transverse sectional views showing the orifices.

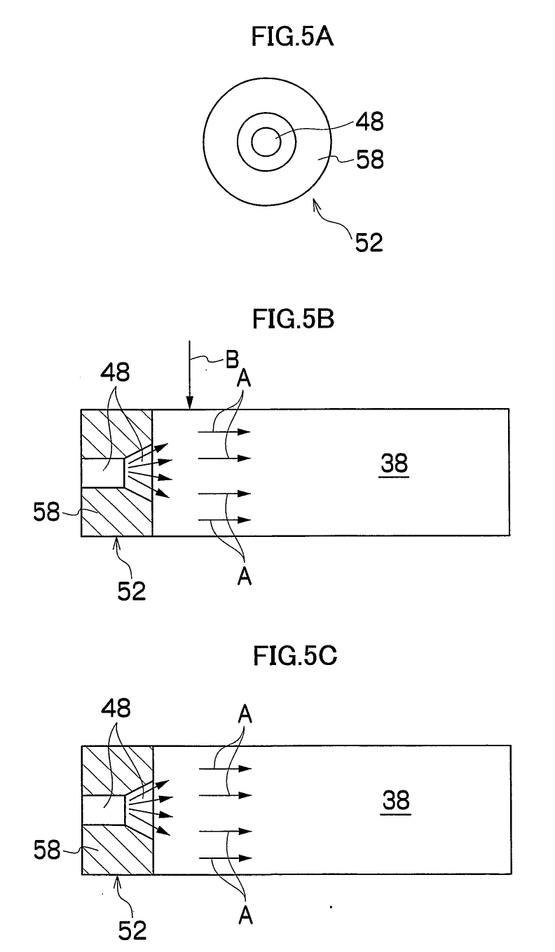

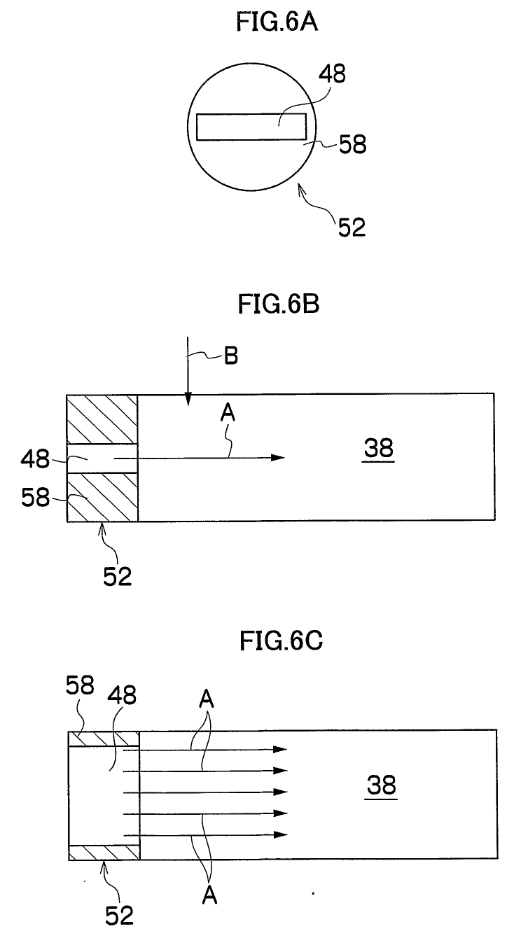

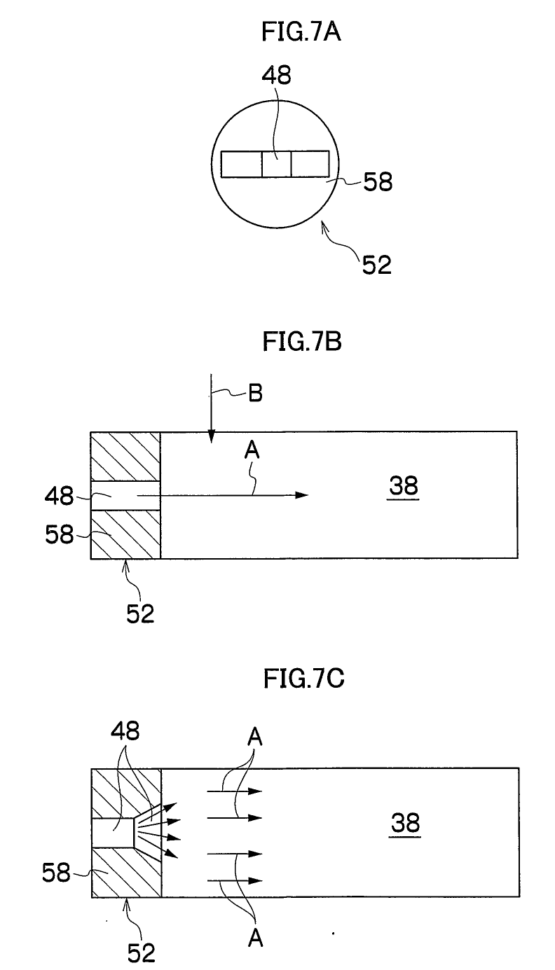

FIGS. 4A to 4C show the first orifice 48 for discharging filar straight flow A into the mixing chamber 38. The first orifice 48 is shaped like a filament. FIGS. 5A to 5C show the first orifice 48 for discharging conical straight flow A into the mixing chamber 38. The first orifice 48 has an open end shaped like a horn. FIGS. 6A to 6C show the first orifice 48 for discharging straight flow A like a thin film into the mixing chamber 38. The first orifice 48 is shaped like a rectangular slit. FIGS. 7A to 7C show the first orifice 48 for discharging fan-shaped straight flow A like a thin film into the mixing chamber 38. The first orifice 48 has an end shaped like a sector.

The mixing device 12 of one-jet mixing method is not limited to FIG. 2. Any configuration is applicable as long as a static mixing device is used, in which the first solution L1 and the second solution L2 are discharged from the nozzles to a mixed field larger in diameter than the nozzles, the solutions are subjected to a mixing reaction in the mixed field, and the mixing reaction liquid LM is discharged from an outlet smaller in diameter than the mixed field. In this mixing device, at least one of the solution L1 and the solution L2 is discharged to the mixed field as a high-pressure jet flow of 1 MPa or higher and a turbulent flow having a Reynolds number of 10000 or more when entering the mixed field, and the remainder of the solutions can be added, with a pressure lower than that of the high-pressure jet flow, on a position before eddy viscosity formed by the high-pressure jet flow relative to the flowing direction is maximized.

### b) T-Shape Type, Y-Shape Type

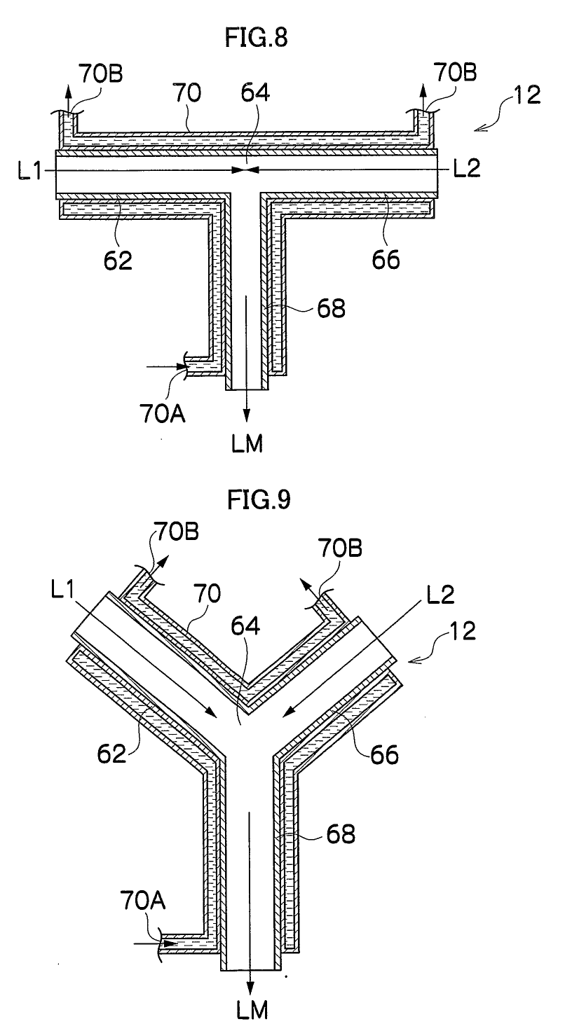

FIGS. 8 and 9 are sectional views showing the mixing devices 12 of T-shape type and Y-shape type. FIG. 8 is a T tube and FIG. 9 shows a Y tube.

As shown in FIGS. 8 and 9, at an intersection (mixed field) of extremely thin tubes like a T tube and Y tube, the first solution L1 and the second solution L2 are caused to collide with each other as high-pressure jet flows of 1 MPa or more, so that the solutions are instantly mixed and the reacted reaction liquid LM is discharged from a discharge pipe in a short time. To be specific, the first solution L1 is discharged from a first addition pipe 62 to a mixed field 64 as a high-pressure jet flow of 1 MPa or more, the second solution L2 is discharged from a second addition pipe 66 to the mixed field 64 as a high-pressure jet flow of 1 MPa or more, and the solutions are caused to collide with each other. The solutions are mixed by energy of collision and the reacted reaction liquid LM is discharged from a discharge pipe 68 in a short time. The pressures of the first solution L1 and the second solution L2 may be either equal or unequal as long as the pressures are 1 MPa or more. A jacket 70 is wound around the first addition pipe 62, the second addition pipe 66, and the discharge pipe 68 to control the mixing reaction temperature of the first and second solutions L1 and L2 in the mixed field 64. In FIGS. 8 and 9, reference numeral 70A denotes a heating medium inlet of the jacket 70 and reference numeral 70B denotes a heating medium outlet.

With this configuration, the first solution L1 and the second solution L2 are mixed and caused to react instantly and efficiently under proper mixing temperature conditions, and the reaction liquid LM is immediately discharged from the discharge pipe 68. Thus, it is possible to form metal fine particles with a small size and high monodispersity. In this case, a residence time is preferably 5 seconds or less.

### c) Opposed Two-Jet Type

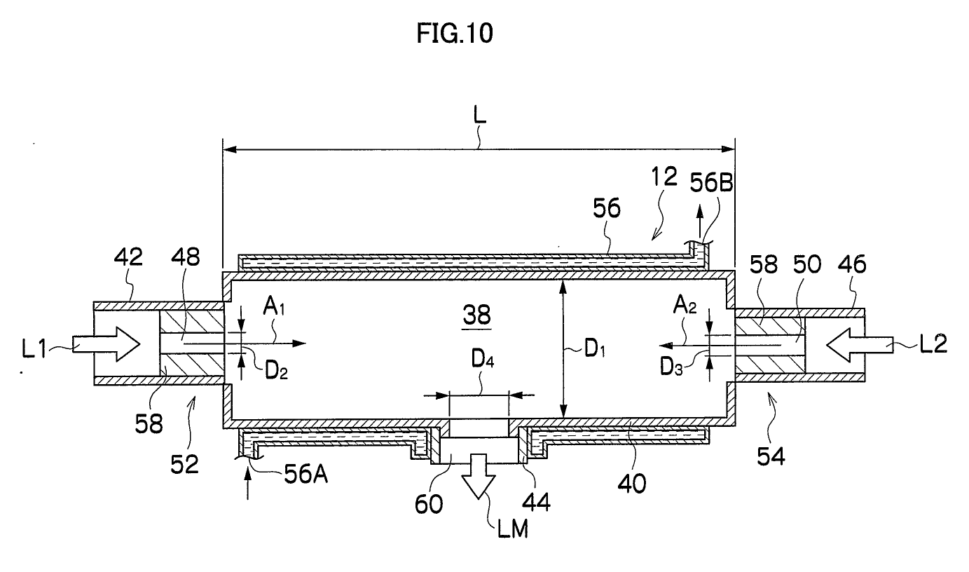

FIG. 10 shows a mixing method in which the concept of eddy viscosity is added to T-shape type. The same members as FIG. 2 are indicated by the same reference numerals. In this mixing method, the first solution L1 and the second solution L2 are discharged in opposite directions as high-pressure jet flows of 1 MPa or more into a mixing chamber 38 (mixed field) which is larger in diameter than nozzles for discharging the solutions L1 and the solution L2, the solutions are caused to collide with each other and mixed using eddy viscosity occurring in the solutions, and the reaction liquid LM is discharged from a discharge pipe 44 which is smaller in diameter than the mixing chamber 38.

A mixing device 12 of FIG. 10 has a first conduit 42 for feeding the first solution L1 to the mixing chamber 38. The first conduit 42 is connected to the opening of one end of a mixer 40 in which the cylindrical mixing chamber 38 is formed to mix the first and second solutions L1 and L2 and cause the solutions to react. Further, the mixing device 12 has a second conduit 46 for feeding the second solution L2 to the mixing chamber 38. The second conduit 46 is connected to the opening of the other end of the mixer 40. The discharge pipe 44 is connected to the opening at the center of the mixer 40. The reaction liquid LM, which has been mixed and reacted in the mixing chamber 38, is discharged from the mixing chamber 38 through the discharge pipe 44.

In the ends of the first conduit 42 and the second conduit 46, a first orifice 48 and a second orifice 50 are provided, so that a first nozzle 52 and a second nozzle 54 are formed in the first conduit 42 and the second conduit 46 to discharge turbulent straight flows A1 and A2. In the present embodiment, the first solution L1 is discharged from the first nozzle 52 and the second solution L2 is discharged from the second nozzle 54. The solutions may be reversed.

A jacket 56 is wound around the mixer 40, and the mixing reaction temperature of the first and second solutions L1 and L2 in the mixer 40 is controlled in the same manner as FIG. 2.

A diameter D1 of the mixing chamber 38, an orifice diameter D2 of the first nozzle 52, an orifice diameter D3 of the second nozzle 54, and the dimensional relationship thereof are similar to those of one-jet type. Moreover, the method of forming the first and second orifices 48 and 50, the material of an orifice member 58, and pressuring device are similar to those of one-jet type. The straight flows A1 and A2 can be formed into a filar shape, a conical shape, a slit, and a sector, which are described in the explanation of one-jet type.

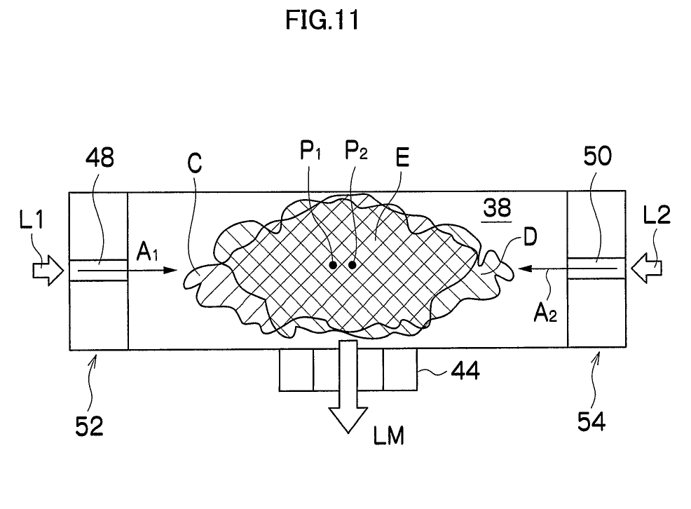

As shown in FIG. 11, from the first nozzle 52 and the second nozzle 54, the first solution L1 and the second solution L2 are discharged as high-pressure jet flows of 1 MPa or more from one end and the other end of the mixing chamber 38, and the solutions are caused to collide with each other as opposing turbulent straight flows A1 and A2 in the mixing chamber 38. Two eddy viscosities C and D formed by the two straight flows A1 and A2 are caused to overlap each other, so that the solution L1 and the solution L2 are instantly mixed under proper mixing reaction temperature conditions and the reacted reaction liquid LM is immediately discharged from the discharge pipe 44. In this case, a residence time in the mixing chamber 38 is preferably 5 seconds or less. Thus, metal fine particles can be formed with a small size and high monodispersity.

In this mixing reaction, when the eddy viscosities C and D are maximized, which are formed by the two straight flows A1 and A2 acting as opposed fast turbulent flows in the mixing chamber 38, the flows are caused to overlap so as to maximize an overlap part E, thereby obtaining mixing efficiency with high performance. Therefore, it is preferable that the straight flows A1 and A2 do not collide with each other immediately after being discharged to the mixing chamber 38, and it is preferable to maximize the overlap part E where the two eddy viscosities C and D formed in the mixing chamber 38 by the straight flows A1 and A2 overlap each other. For this purpose, it is preferable to suitably set a distance L (FIG. 10) between the opposing first and second nozzles 52 and 54, that is, the length of the mixed field. Since the distance L between the first and second nozzles 52 and 54 is properly set, the overlap part E of the maximized eddy viscosities C and D can be positively increased and the two eddy viscosities C and D can be caused to overlap each other in an almost perfect manner. Therefore, it is necessary to locate the position where the eddy viscosities C and D are maximized. Regarding the position where the eddy viscosities C and D are maximized in the mixing chamber 38, a distance from the first nozzle 52 to the eddy viscosity C and a distance from the second nozzle 54 to eddy viscosity D can be recognized by performing a simulation beforehand using RFLOW, which is numerical analysis software of Rflow Co., Ltd. RFLOW is well known as flow analysis software commercially available in Japan. In this case, as shown in FIG. 11, the eddy viscosities C and D are maximized not on a point but over an area. Therefore, the distance L between the first nozzle 52 and the second nozzle 54 is the total of a distance between the first nozzle 52 and point P1 where the eddy viscosity C is maximized and a distance between the second nozzle 54 and point P2 where the eddy viscosity D is maximized. The points P1 and P2 are disposed almost at the center of the eddy viscosities C and D and the points P1 and P2 are matched with each other. In another method for locating the points P1 and P2, according to an analysis of the numerical analysis software, the points P1 and P2 where the eddy viscosities C and D are maximized by the straight flows A1 and A2 relate to the flow velocities of the straight flows A1 and A2. The points P1 and P2 almost correspond to positions where the maximum flow velocities of the straight flows A1 and A2 (normally a flow velocity at the first or second nozzle) are reduced to one tenth. Thus, the points P1 and P2 may be located by calculating positions where the maximum flow velocities of the straight flows A1 and A2 are reduced to one tenth. In this way, the eddy viscosities C and D are caused to overlap each other at positions where the eddy viscosities C and D are maximized, so that contact efficiency on a liquid-liquid interface of the straight flow A1 and the straight flow A2 is increased and mixing performance is improved. Additionally, it is possible to reduce heat generated by liquid-liquid friction caused by the collision of the straight flow A1 and the straight flow A2.

### (B) Degassing Device

The degassing device 14 of the present invention may be any device as long as gas bubbles generated with the progress of a reaction can be efficiently removed from the reaction liquid LM and do not interfere with the progress of the reaction or the flow of the reaction liquid LM. The following degassing device 14 is preferably used:

### a) Vertically Meandering Flow Method

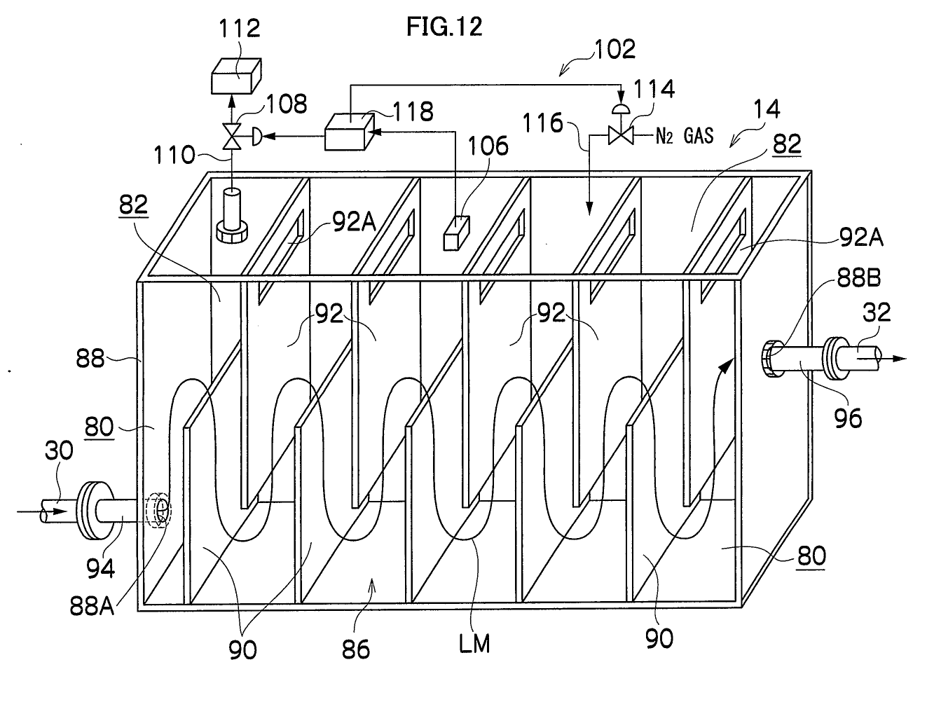

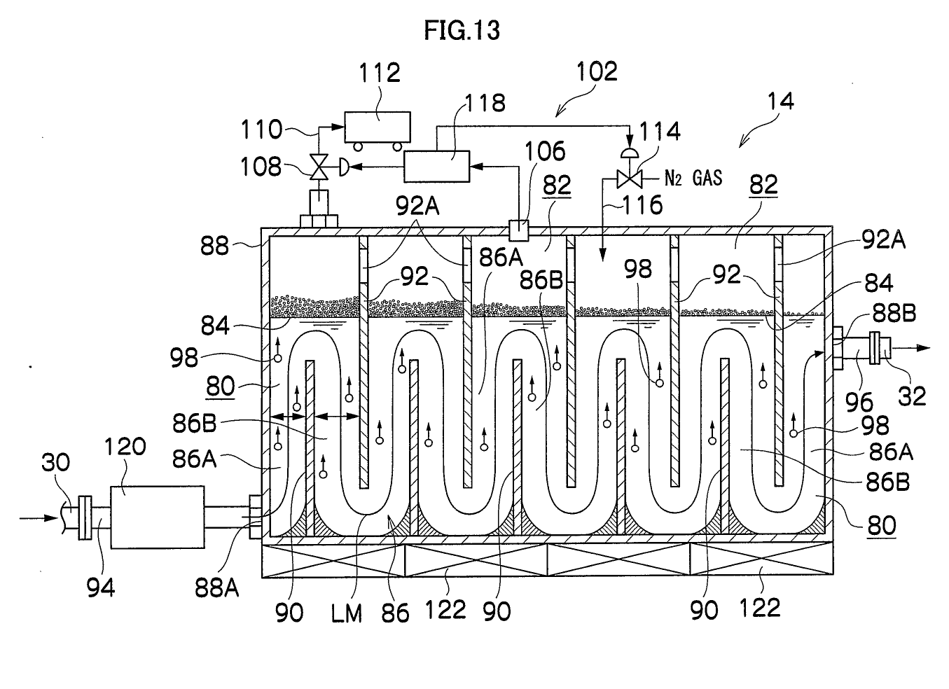

The degassing device 14 of vertically meandering flow method shown in FIGS. 12 and 13 is formed as a path 86 which has a gas-liquid interface 84 of a liquid part 80 of the reaction liquid LM and a space 82 for storing gas removed from the reaction liquid LM. In a degassing container 88 having an inlet 88A and an outlet 88B, a plurality of sheathing boards 90 are raised from the bottom of the degassing container 88 at certain intervals. The upper ends of the sheathing boards 90 are disposed below the gas-liquid interface 84. Between the sheathing boards 90, a plurality of baffles 92 are hung from the ceiling board of the degassing container 88. The lower ends of the baffles 92 are separated from the bottom of the degassing container 88. With this configuration, as shown in FIG. 13, the reaction liquid LM continuously flows such that upflow paths 86A and downflow paths 86B are alternately formed in a consecutive manner in the degassing container 88. The gas-liquid interface 84 is formed on a part where the flow is reversed from the upflow path 86A to the downflow path 86B. The path 86 composed of the upflow paths 86A and the downflow paths 86B has to be long enough to enable sufficient degassing. An inflow pipe 94 is connected to the inlet 88A of the degassing container 88, and the inflow pipe 94 is connected to the pipe 30 (FIG. 1) via a flange. An outflow pipe 96 is connected to the outlet 88B of the degassing container 88, and the outflow pipe 96 is connected to the pipe 32 (FIG. 1) via a flange. The outflow pipe 96 has to be connected somewhat higher than the upper ends of the sheathing boards 90 such that the gas-liquid interface 84 is higher than the upper ends of the sheathing boards 90. However, when a valve is disposed in the outflow pipe 96 to reduce an outflow from the outflow pipe 96 according to an inlet from the inflow pipe 94, the outflow pipe 96 may be connected to the lower part of the degassing container 88.

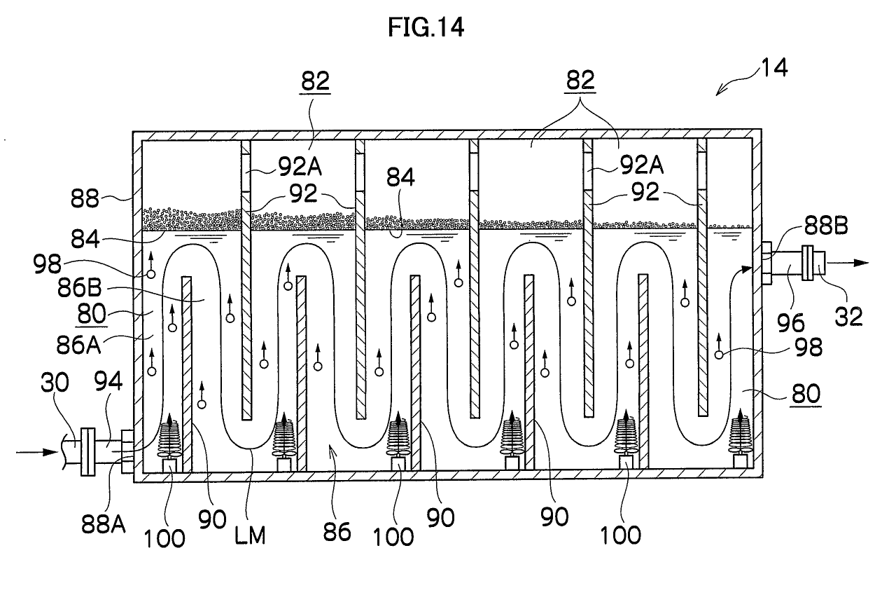

In the degassing device 14 configured by vertically meandering flow method, the reaction liquid LM mixed in the mixing device 12 flows from the inflow pipe 94 into the degassing device 14. While the reaction liquid LM alternately flows through the upflow paths 86A and the downflow paths 86B, gas bubbles 98 having been generated with the progress of a reaction float to the gas-liquid interface 84 in the path 86 and are removed from the gas-liquid interface 84 to the spaces 82. In this case, the bottom of the degassing container 88 is preferably formed like arcs where the flow of the reaction liquid LM is reversed from the downflow paths 86B to the upflow paths 86A. Since the reaction liquid LM smoothly flows without remaining in the bottom of the degassing container 88, the bubbles 98 or metal fine particles serving as reaction products do not remain in the bottom of the degassing container 88. In another embodiment, as shown in FIG. 14, agitators 100 may be provided in the bottoms of the upflow paths 86A to generate flows preventing liquid from remaining. With the agitators 100, a reversing flow can be formed with a large force when the reaction liquid LM is reversed from the downflow path 86B to the upflow path 86A, thereby preventing the bubbles 98 and metal fine particles from remaining in the bottom of the degassing container 88.

In order to prevent the path 86 from extending too long, it is preferable that the sheathing boards 90 become lower, one by one, from the inlet 88A to the outlet 88B of the degassing device 14. This is because a large amount of gas is generated at the inlet and a small amount of gas is generated at the outlet from the reaction liquid LM in the path 86 formed in the degassing container 88. Therefore, a path length to the gas-liquid interface 84 has to be long at the inlet of the path 86. By setting the sheathing boards 90 lower one by one from the inlet 88A to the outlet 88B of the degassing container 88, a proper path length to the gas-liquid interface 84 can be obtained according to an amount of generated gas. With this configuration, it is possible to prevent the path 86 from extending too long, so that degassing can be efficiently performed in a short time.

As shown in FIGS. 12 and 13, the degassing device 14 preferably comprises pressure adjusting device 102 for adjusting the pressure of the space 82. The pressure of the space 82 is changed by the generation of bubbles. In the case where the pressure of the overall space 82 is uniformly adjusted by the pressure adjusting device 102, communicating holes 92A are formed on parts of the baffles 92 so as to correspond to the spaces 82.

The pressure adjusting device 102 is mainly constituted of a pressure sensor 106 for measuring the pressure of the space 82, a gas vent pipe 110 with a valve 108 for discharging gas remaining in the spaces 82, a decompressing device 112 connected to the gas vent pipe 110, a gas supply pipe 116 with a valve 114 for supplying inert gas such as nitrogen gas to the spaces 82, and a control unit 118. The decompressing device 112 may be a vacuum pump or an aspirator. The control unit 118 adjusts the valves 108 and 114 of the gas vent pipe 110 and/or the gas supply pipe 116 according to a pressure measured by the pressure sensor 106 in the space 82, so that the pressure of the space 82 can be properly adjusted. In other words, the pressure of the space 82 is adjusted such that the bubbles 98 in the reaction liquid LM flowing through the path 86 of the degassing device 14 can be easily moved to the space 82 through the gas-liquid interface 84. It is better to reduce the pressure of the space 82 to facilitate degassing. Excessive decompression, however, brings the reaction liquid LM to a boil and causes a turbulent flow. Thus, excessive decompression is adjusted by supplying inert gas such as nitrogen gas to the space 82. The level of decompression varies according to an amount of generated gas bubbles and a floating force or the like corresponding to the size of a bubble, and thus the level of decompression is adjusted while monitoring a degassing state. Therefore, it is preferable to observe the bubbles 98 removed from the reaction liquid LM passing through the path 86, and it is preferable to form a transparent container as the degassing container 88.

In this degassing, in order to obtain a stable and uniform reaction, it is extremely important to smoothly degas the reaction liquid LM in a continuous manner (without disturbing a liquid flow) while precisely keeping a fixed pressured in the space 82, and stabilize the flow of the reaction liquid LM.

For this reason, the valves 108 and 114 used for the pressure adjusting device 102 preferably open and close with a response speed of 10 msec or less. The valves 108 and 114 with a response speed of 5 msec or less are more preferable. The valves 108 and 114 opening and closing with a response speed of 5 msec or less may be servo valves. Hence, when the measured value of the pressure sensor 106 is varied from a predetermined pressure of the space 82, the valves 108 and 114 open or close with an extremely high opening/closing speed, and thus the pressure of the space 82 is not changed. When the response speeds of the valves 108 and 114 are 10 msec or more, a resistor (not shown) for reducing the discharge speed of gas may be disposed somewhere in the gas vent pipe 110 including the valves 108 and 114 to facilitate pressure control. An orifice, a filter, and so on are preferably used as the resistor.

If a reaction does not accept oxygen in the air or gas generated by a reaction is hydrogen gas, the presence of oxygen may be dangerous. In this case, inert gas such as nitrogen gas can be supplied from the gas supply pipe 116, and thus it is preferable to purge inert gas into the degassing container 88 from the gas supply pipe 116 to replace air in the degassing container 88 with inert gas before operating the reaction apparatus 10.

In the present embodiment, the communicating holes 92A are formed on parts of the baffles 92 so as to correspond to the spaces 82. The pressure adjusting device 102 may be provided, without communicating holes 92A, for each the spaces 82 partitioned by the baffles 92 to separately adjust the pressures of the spaces 82. As described above, a large amount of gas is generated from the reaction liquid LM at the inlet of the degassing device 14 and a small amount of gas is generated at the outlet of the degassing device 14. Thus, gas generated near the inlet has to be quickly removed from the spaces 82 to prevent pressure increase in the spaces 82. Hence, by adjusting a pressure for each of the spaces 82 partitioned by the baffles 92, the pressure of each of the spaces 82 is properly controlled according to an amount of generated gas and facilitates the degassing of the bubbles 98 in each of the spaces 82.

In order to promote the degassing of the bubbles 98 in the reaction liquid LM, as shown in FIG. 13, a temperature adjusting device 120 is preferably provided at some midpoint of the inflow pipe 94. The temperature adjusting device 120 heats or cools the reaction liquid LM flowing into the degassing device 14. In this case, the degassing device 14 may be entirely heated or cooled by a heater, a cooling coil, and the like embedded in the degassing container 88, the sheathing boards 90, and the baffles 92. The reaction liquid LM is heated or cooled by properly setting the temperature of the temperature adjusting device 120 and so on while observing the degassing of the bubbles 98.

With this configuration, a reaction temperature is controlled by heating or cooling the reaction liquid LM flowing in the degassing device 14, so that reaction conditions can be fixed all the time regardless of an air temperature and an ambient temperature. Thus, an amount of generated gas can be kept regardless of an air temperature. It is therefore possible to accurately perform degassing and reproduce an amount of degassing in the designed degassing device regardless of seasons and an ambient temperature, so that the shape and capacity of the device can be fixed.

As shown in FIG. 13, it is also preferable to provide an ultrasonic generator 122 to promote the degassing of the bubbles 98 in the reaction liquid LM. The position of the ultrasonic generator 122 is not particularly limited. For example, the ultrasonic generator 122 is preferably disposed outside the bottom of the degassing device 14 as shown in FIG. 13. The oscillation frequency of an ultrasonic wave is preferably 1 kHz to 10 MHz, more preferably 1 kHz to 1 MHz, and particularly preferably 20 kHz to 200 kHz. The output of an ultrasonic wave is preferably 1 w to 10 kW, more preferably 10 W to 5 kW, and particularly preferably 100 W to 2 kW. In this way, a supersonic vibration is added to the reaction liquid LM, so that it is possible to accelerate the degassing of the bubbles 98 in the reaction liquid LM and easily remove the bubbles 98 adhering on the inner wall surface of the degassing container 88, a surface of the sheathing board 90, and a surface of the baffle 92. In this case, it is more preferable to perform surface treatment such as Teflon™ coating on the inner wall surface of the degassing container 88, the surface of the sheathing board 90, and the surface of the baffle 92 to prevent the adhesion of the bubbles 98.

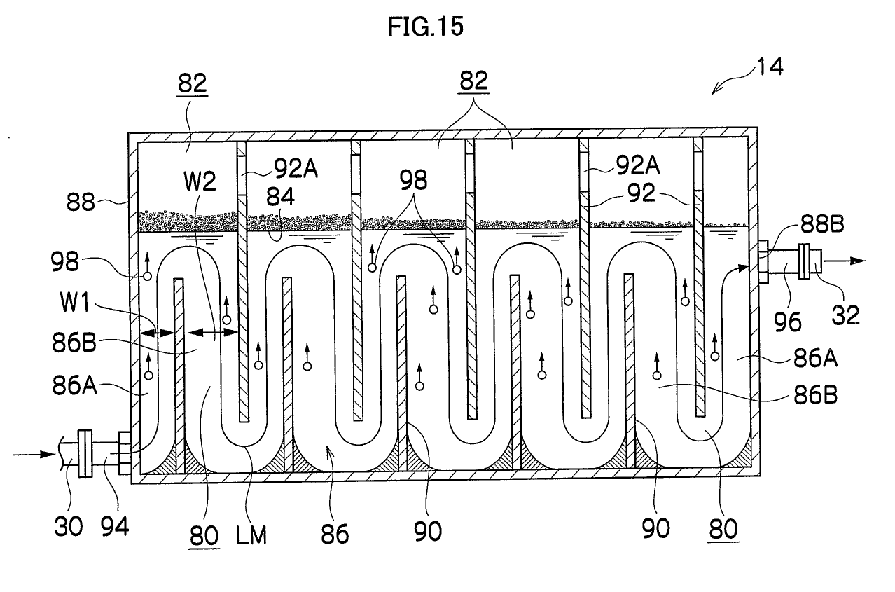

In order to promote the degassing of the bubbles 98 in the reaction liquid LM, as shown in FIG. 15, it is preferable that a width W2 of the downflow path 86B is larger than a width W1 of the upflow path 86A and the cross sectional area of the downflow path 86B is larger than that of the upflow path 86A. In the upflow path 86A, the flowing direction of the reaction liquid LM and the floating direction of the bubbles 98 are the same, and thus the bubbles 98 are easily raised and separated on the gas-liquid interface 84, whereas in the downflow path 86B, the flowing direction of the reaction liquid LM and the floating direction of the bubbles 98 are opposite, and thus the bubbles 98 are hard to raise and separate on the gas-liquid interface 84. Therefore, in the downflow path 86B, the downflow velocity of the reaction liquid LM has to be lower than the upflow velocity of the bubbles 98. In this case, the floating speed of the bubble 98 varies according to a bubble diameter. Thus, it is necessary to properly design the downflow velocity of the downflow path 86B according to the bubble diameter, that is, the floating speed. The pressure adjusting device 102 is omitted in FIGS. 14 and 15.

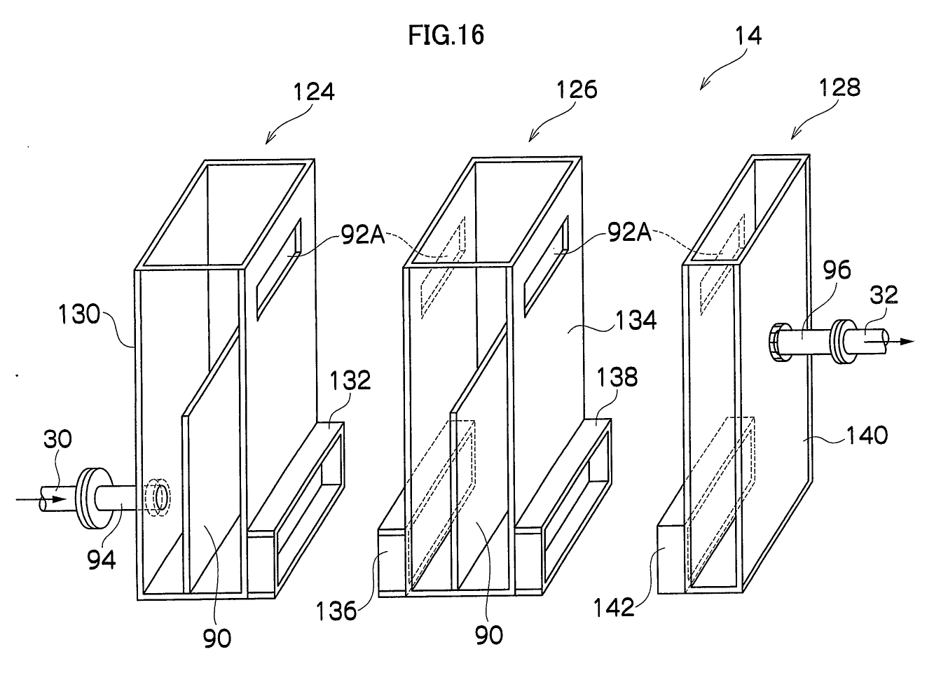

In FIG. 16, the degassing device 14 comprises an inlet unit 124, an intermediate unit 126, and an outlet unit 128, so that the overall length of the path 86 can be easily adjusted.

As shown in FIG. 16, the inlet unit 124 has a sheathing board 90 rising in a box 130, an inflow pipe 94 connected to the lower part of one side of the box 130, and an outlet duct 132 laterally protruding on the lower part of the other side of the box 130. The intermediate unit 126 has a sheathing board 90 rising in a box 134, an inlet duct 136 laterally protruding on the lower part of one side of the box 134, and an outlet duct 138 laterally protruding on the lower part of the other side of the box 134. The outlet unit 128 has an inlet duct 142 protruding on the lower part of one side of a box 140 and an outflow pipe 96 connected to the upper part of the other side of the box 140. In the units 124, 126, and 128, communicating holes 92A for equalizing the pressures of the spaces 82. The inlet ducts 136 and 142 and the outlet ducts 132 and 138 of the units 124, 126, and 128 are fit into each other with watertightness.

When the degassing device 14 is assembled by the inlet unit 124, the intermediate unit 126, and the outlet unit 128, the outlet duct 132 of the inlet unit 124 and the inlet duct 136 of the intermediate unit 126 are fit into each other, and the outlet duct 138 of the intermediate unit 126 and the inlet duct 142 of the outlet unit 128 are fit into each other. The sides of the units 124, 126, and 128 mated by the fitting act as the baffles 92. With this configuration, the degassing device 14 can be easily manufactured and the overall length of the path 86 in the degassing device 14 can be freely adjusted only by changing the number of the intermediate units 126. When the communicating holes 92A are formed in the units 124, 126, and 128, the pressure adjusting device is provided in any one of the units. When the communicating holes 92A are not formed, the pressure adjusting device 102 for adjusting the pressure of the space 82 is provided in each of the units. It is more preferable to provide various devices and shapes for promoting degassing. For example, the temperature adjusting device 120, the ultrasonic wave supply device 122, the agitators 100 are preferably provided and the bottom of the unit is preferably shaped like an arc.

### b) Gas Transmission Method

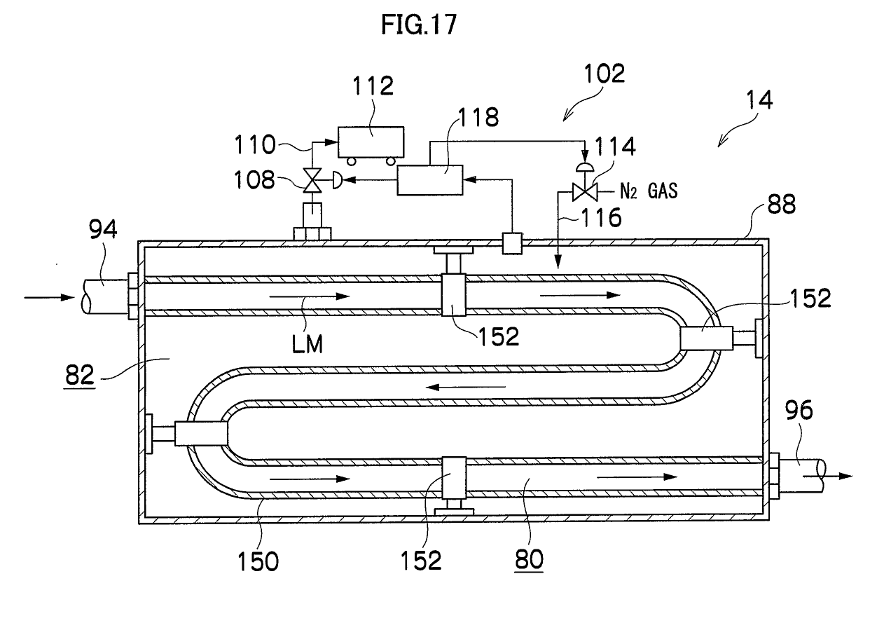

As shown in FIG. 17, in a degassing device 14 of gas transmission method, an inflow pipe 94 is connected to the upper part of one side of a degassing container 88 and an outflow pipe 96 is connected to the lower part of the other side of the degassing container 88. In the degassing container 88, a degassing pipe 150 is stored like a reversed letter S. The degassing pipe 150 is formed of a gas transmitting member not allowing the passage of liquid but allowing the passage of gas. One end of the degassing pipe 150 is connected to the inflow pipe 94 and the other end of the degassing pipe 150 is connected to the outflow pipe 96. The two or more points of the degassing pipe 150 are supported on the inner wall surface of the degassing container 88 via holders 152.

When manufacturing the degassing device 14 of gas transmission method, the most important point is to use a gas transmitting member achieving excellent gas transmission. Films such as a Gore-Tex Film™ with excellent gas transmission have become commercially available in the recent development of polymer technology. As micromachining technology advances in recent years, extremely fine holes not allowing the passage of liquid but allowing the passage of gas can be formed on a hard resin such as a metallic or plastic resin, and thus a gas transmitting member can be manufactured using this technology. In any event, regardless of the advance of technology, any member may be used for the degassing device 14 of gas transmission method as long as the member is a gas transmitting member allowing only the passage of gas generated by a liquid-liquid reaction. In this case, the degassing pipe 150 does not have to be entirely formed of the gas transmitting member as long as the upper part of the degassing pipe 150 is formed of the gas transmitting member. With this configuration, the degassing device 14 is formed in which a gas-liquid interface of a liquid part 80 of the reaction liquid LM and a space 82 for storing gas removed from the reaction liquid LM is divided by the degassing pipe 150 formed of the gas transmitting member in the degassing container 88.

According to the degassing device 14 of gas transmission method, the reaction liquid LM mixed in the mixing device 12 flows from the inflow pipe 94 into the degassing device 14. While the reaction liquid LM passes through the degassing pipe 150, gas generated by a reaction rises as bubbles 98 in the reaction liquid, passes through the degassing pipe 150 formed of the gas transmitting member, and are removed to the space 82.

In this degassing, according to the gas transmission capability of the gas transmitting member forming the degassing pipe 150, the pressure adjusting device for adjusting the pressure of the space 82 is preferably provided to reduce the pressure in the space 82. The configuration of the pressure adjusting device 102 is identical to that of the degassing device of vertically meandering method and thus the explanation thereof is omitted.

As described above, according to the reaction apparatus 10 of the present invention, the mixing device 12 and the degassing device 14 are separated from each other, mixing is performed evenly and efficiently without being interfered by the gas bubbles 98 generated by a reaction. Thus, it is possible to stabilize a reaction at the start of the reaction and in the progress of the reaction and stably feed liquid to a subsequent process.

According to the reaction apparatus 10 of the present invention, high-pressure mixing method is used for the mixing device 12, so that mixing can be instantly performed and the reaction liquid LM, in which gas has been generated after the start of a mixing reaction, can be immediately fed to the degassing device 14. Hence, gas bubbles do not interfere with mixing in the mixing device 12.

Further, according to the reaction apparatus 10 of the present invention, the path 86 is formed in the degassing device 14. The path 86 has the gas-liquid interface 84 of the liquid part 80 of the reaction liquid LM and the space 82 for storing gas removed from the reaction liquid LM. The gas bubbles 98 in the reaction liquid passing through the path 86 are continuously removed to the space 82. Thus, it is possible to efficiently perform degassing using the floating force of the bubbles 98.

Therefore, the reaction apparatus 10 of the present invention is suitable for a reaction system of flow method. In this method, a gas generating reaction is caused to occur in the flow of the reaction liquid LM. Particularly when the reaction apparatus 10 of the present invention is used for sequentially manufacturing magnetic particles contained in the magnetic layer of a magnetic recording medium, a gas generating reaction can be uniform. Moreover, the equilibrium of a reaction is moved to a reaction acceleration side by continuous degassing. Since reactivity improves, a quick reaction is achieved and thus magnetic particles can be smaller in size. When a liquid temperature is controlled for degassing, gas can be efficiently removed in the flow of continuous processing, so that a liquid temperature can be controlled with higher accuracy. Therefore, it is possible to manufacture magnetic particles with a small size and high monodispersity, and manufacture a high-precision magnetic recording medium by containing the magnetic particles in a magnetic layer.

### EXAMPLE 1

The following is an example of Embodiment 1 of the present invention. Embodiment 1 is not limited to this example.

An operation was performed in high purity nitrogen gas as follows:

An alkene solution prepared by mixing 10.8 g of aerosol OT (Wako Pure Chemical Industries, Ltd.), 80 ml of decane (Wako Pure Chemical Industries, Ltd.), and 2 ml of oleyl amine (Tokyo Kasei Kogyo Co., Ltd.) was added and mixed in a reducer solution prepared by dissolving 0.50 g of NaBH4 (Wako Pure Chemical Industries, Ltd.) in 16 ml of H₂O (deoxidized to 0.1 mg/l or less of dissolved oxygen), so that the reserved micelle solution of the first solution L1 was prepared.

An alkene solution prepared by mixing 7.0 g of aerosol OT (Wako Pure Chemical Industries, Ltd.) and 40 ml of decane (Wako Pure Chemical Industries, Ltd.) was added and mixed in a metallic salt solution prepared by dissolving 0.6 g of triammonium iron (III) trioxalate (Fe(NH4)₃(C₂O₄)₃) (Wako Pure Chemical Industries, Ltd.) and 0.50 g of potassium chloroplatinate (K₂PtCl₄) (Wako Pure Chemical Industries, Ltd.) in 8 μm of H₂O (deoxidized to 0.1 mg/l or less of dissolved oxygen), so that a reserved micelle solution of the second solution L2 was prepared.

In the conventional method of manufacturing metal fine particles, the two reserved micelle solutions (L1, L2) were agitated and mixed in a batch manner in a tank for ten minutes and caused to react therein. Metal fine particles obtained thus will be referred to as a sample of the conventional method.

In contrast to the conventional method, in the reaction apparatus 10 of the present invention, the reversed micelle solution (L1) and the reversed micelle solution (L2) were instantly mixed using the mixing device 12 of FIG. 2. The reaction liquid LM was extracted from the mixing device 12 at the completion of mixing and gas was removed by the degassing device 14 of vertically meandering flow method shown in FIG. 12. Meanwhile, the reaction liquid LM was collected to a collection tank 23 after ten minutes. Metal fine particles obtained thus will be referred to as a sample of the present invention method.

The following operation is performed in the conventional method and the present invention method. Thereafter, the sample of the conventional method and the sample of the present invention method were both raised to 50° C. and aged for 60 minutes while being agitated by a magnetic stirrer. Then, 2 ml of oleric acid (Wako Pure Chemical Industries, Ltd.) was added and mixed in the samples. The samples were cooled to room temperature and then extracted to the air. In order to destroy reversed micelles, a mixed solution of 100 ml of H₂O (deoxidized to 0.1 mg/l or less of dissolved oxygen) and 100 ml of methanol was added to the samples, and the samples were each divided into an aqueous phase and an oil phase. Metal nanoparticles were dispersed on the side of the oil phase. The side of the oil phase was cleaned five times with a mixed solution of 600 ml of H₂O (deoxidized to 0.1 mg/l or less of dissolved oxygen) and 200 ml of methanol. Thereafter, 1100 ml of methanol was added to cause flocculation on metal nanoparticles, and then the metal nanoparticles were settled. A supernatant fluid was removed and 20 ml of heptane (Wako Pure Chemical Industries, Ltd.) was added and the metal nanoparticles were dispersed again. Then, 100 ml of methanol was added to settle the metal nanoparticles. This processing was repeated three times. Finally, 5 ml of octane (Wako Pure Chemical Industries, Ltd.) was added, so that a solution of dispersed metal nanoparticles of FePt was obtained with a mass ratio (water/a surface-active agent) of 2 between water and a surface-active agent.

Regarding metal nanoparticles obtained by the conventional method and metal nanoparticles obtained by the present invention method, a yield, a composition, a volume average grain size, and a grain size distribution (coefficient of variation), and a coercive force were measured. A composition and a yield were measured by ICP spectrochemical analysis (inductively coupled plasma spectrometry). A volume, an average grain size, and a grain size distribution were determined by measuring particles, which have been photographed by TEM, and performing statistical processing. A coercive force was measured using high-sensitivity magnetization vector measurement equipment (Toei Industry Co., Ltd.) and DATA processing equipment (Toei Industry Co., Ltd.) with an applied magnetic field of 790 kA/m (10 kOe). Metal nanoparticles for measurement were collected from a prepared fluid dispersion of metal panoparticles, sufficiently dried, and heated in an electric furnace for 30 minutes at 550° C. before measurement.

Table 1 shows the measurement results of Example 1 on metal nanoparticles of the conventional method and metal nanoparticles of the present invention method.

TABLE 1

| | | Metal nanoparticles |
|---|---|---|
| | Metal nanoparticles of | of present |
| | conventional method | invention method |
| Yield | 85% | 90% |
| Composition | FePt = 69.5/30.5 | FePt = 55.5/44.5 |
| Volume average grain size | 5.0 nm | 5.0 nm |
| Grain size distribution | 10% | 5.3% |
| (coefficient of variation) | | |
| Coercive force | 576.7 kA/m | 580.7 kA/m |

As is understood from the results of Table 1, the metal nanoparticles of the present invention method were smaller in size with high monodispersity as compared with the metal nanoparticles of the conventional method. Further, as compared with the conventional method, the present invention method has a higher yield and a higher content of Pt in its composition.

### Embodiment 2

Embodiment 2 describes a method and apparatus for manufacturing a chemical substance according to the present invention by use of the reaction method and apparatus of Embodiment 1 of the present invention. The following is an example in which manufactured chemical substances are metal fine particles contained in a magnetic layer of a magnetic recording medium. The metal fine particles are manufactured in a continuous flow by using a solution L1, a solution L2, a solution L3, and a solution L4.

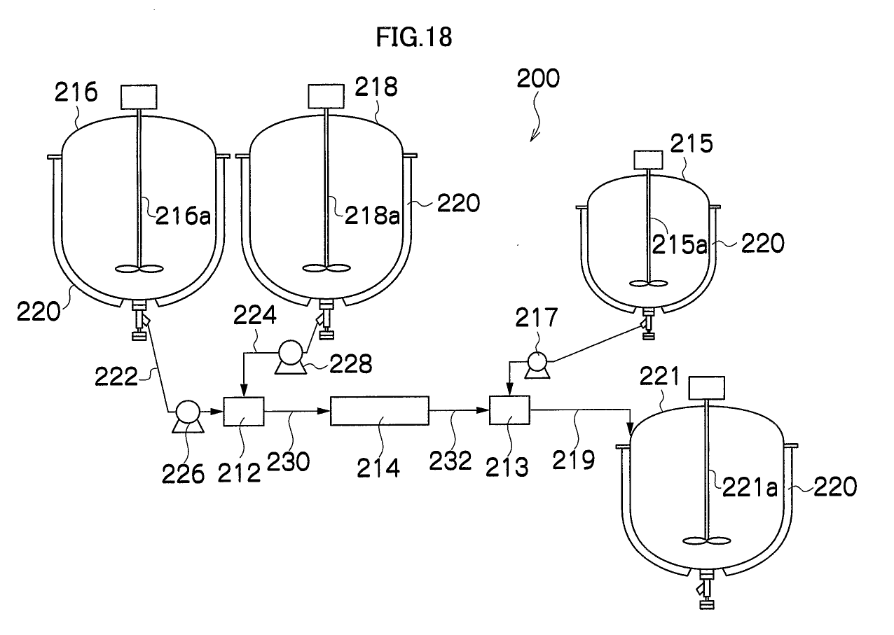

FIG. 18 is an overall structural diagram showing a production unit 200 for a chemical substance according to the present invention. A first mixing device 212 for mixing the solution L1 and the solution L2 and a degassing device 214 for removing gas generated by a reaction are similar to those of Embodiment 1. In Embodiment 2, a second mixing device 213 for adding and mixing the solution L3 is provided after the degassing device 214.

As shown in FIG. 18, the production unit 200 for a chemical substance is mainly configured such that the degassing device 214 is disposed between the sealed first mixing device 212 and the second mixing device 213. The degassing device 214 removes gas bubbles from a reaction liquid LM. The gas bubbles are generated from the reaction liquid LM having been subjected to a mixing reaction in the first mixing device 212. The first mixing device 212 mixes the first solution L1 and the second solution L2 and initiates a reaction. The second mixing device 213 adds the third solution L3 to the reaction liquid LM having been subjected to a mixing reaction in the first mixing device 212, and initiates a mixing reaction.

As in Embodiment 1, the first solution L1 preferably contains two or more kinds of metal ions selected from groups 8, 9, and 10 of the periodic table. Metals ions of Fe, Pt, Co, Ni, and Pd are preferable. The second solution L2 is preferably a reducer solution as in Embodiment 1.

The third solution L3 preferably contains one or more kinds of metal ions selected from groups 11, 12, 13, 14, and 15 of the periodic table. Metal ions of Cu, Ag, Au, Al, Zn, and Sn are preferable.

Among liquid-phase reaction methods, reversed micelle method is preferable by which the size of a metal fine particle can be easily controlled. The first to third solutions L1 to L3 are preferably prepared as reversed micelle solutions by using a water-insoluble organic solvent containing a surface-active agent. The same surface-active agent as Embodiment 1 is used.

The first solution L1 and the second solution L2 are separately prepared in a first preparation tank 216 and a second preparation tank 218 which are disposed near the first mixing device 212. In the first preparation tank 216, a water-insoluble organic solvent containing a surface-active agent and a metallic salt solution containing two or more kinds of metal ions selected from groups 8, 9, and 10 of the periodic table are mixed by an agitator 216a to prepare a reversed micelle solution of the first solution L1. In the second preparation tank 218, a water-insoluble organic solvent containing a surface-active agent and a reducer solution are mixed by an agitator 218a to prepare a reversed micelle solution of the second solution L2. Further, heating jackets 220 are provided around the first preparation tank 216 and the second preparation tank 218 to heat the tanks to a proper temperature for an initial reaction.

The third solution is prepared in a third preparation tank 215 disposed near the second mixing device 213. To be specific, a water-insoluble organic solvent containing a surface-active agent and a metallic salt solution containing one or more kinds of metal ions selected from groups 11, 12, 13, 14, and 15 of the periodic table are mixed by an agitator 215a to prepare a reversed micelle solution of the third solution L3. A heating jacket 120 is provided around the third preparation tank 215 to heat the tank to a proper temperature.

The first and the second solutions L1 and L2 having been prepared by the first and second preparation tanks 216 and 218 are supplied to the first mixing device 212 by supply pumps 226 and 228 through supply pipes 222 and 224, respectively. The two solutions L1 and L2 are instantly mixed in the first mixing device 212, quickly discharged therefrom, passed through a pipe 230, and fed to the degassing device 214. The mixing in the first mixing device 212 initiates a reaction and gas is continuously generated from the reaction liquid LM with the progress of the reaction. The reaction liquid LM having started its reaction in the first mixing device 212 continues to react in the degassing device 214, and the generated gas is continuously removed through a gas-liquid interface. At the completion of degassing, the reaction liquid LM is passed through a pipe 232 and fed to the second mixing device 213. The third solution L3 is added from the third preparation tank 215 to the second mixing device 213 through a supply pump 217. In the second mixing device 213, the third solution L3 and the reaction liquid LM having been degassed in the degassing device 214 are mixed, and dissimilar metal atoms are continuously introduced (doped) into the crystal lattice of metal fine particles formed by an initial reaction. Thus, metal fine particles of multi-component alloys are manufactured. A product liquid containing the generated metal fine particles is fed to a product tank 221 through a pipe 219. In this case, it is preferable to add and mix a fourth solution L4, which is obtained by mixing a chelating agent solution and a reducer solution, to the product liquid having been mixed in the second mixing device 213. Thus, an agitator 221a is provided in the product tank 221, a jacket 220 is provided around the product tank 221, and the product liquid is heated or cooled when necessary.

In a reaction system where gas is generated by a chemical reaction, it is significant to efficiently mix the first and second solutions L1 and L2 in the first mixing device 212 without being interfered by generated gas, enable the degassing device 214 to efficiently perform degassing continuously on gas generated with the progress of the reaction, and leave no gas bubbles in the reaction liquid fed to the second mixing device 213.

According to the production unit 200 for a chemical substance of the present invention, as in Embodiment 1, the sealed mixing device 212 for mixing the plurality of solutions L1 and L2 to start a reaction is separated from the degassing device 214 having a gas-liquid interface for removing, from the reaction liquid LM, gas bubbles generated when the reaction is started by mixing, and the reaction liquid LM mixed in the mixing device 212 is fed to the degassing device 214. Thus, it is possible to uniformly and efficiently perform mixing in the mixing device 112 without being interfered by gas bubbles generated by a reaction. With this configuration, mixing efficiency can be increased and thus it is possible to eliminate an unreacted substance and increase the yield of metal fine particles.

Gas bubbles generated with the progress of a reaction are efficiently removed in a continuous manner in the degassing device 214, and thus the reaction can be stabilized also in the progress of the reaction. Further, continuous degassing stabilizes the flow of the reaction liquid LM in the degassing device 214, and thus liquid can be stably fed to a subsequent process. With this configuration, a stable amount of the reaction liquid LM is always fed to the second mixing device 213. Thus, a mixing reaction can be initiated with a correct ratio between the amount of the reaction liquid LM and a prescribed amount of the third solution L3 added from the third preparation tank 215. Since the reaction liquid LM fed to the second mixing device 213 has no bubbles, mixing can be uniformly and efficiently performed in the second mixing device 213 without being interfered by bubbles. With this configuration, mixing efficiency can be increased and thus it is possible to eliminate an unreacted substance and increase the yield of metal fine particles.

In the present invention, for example, when a reaction rate is high and gas bubbles appear immediately after the completion of mixing in the first mixing device 212, as in Embodiment 1, a time period from the end of mixing in the first mixing device 212 to the start of degassing in the degassing device 214 is preferably set at about 0.1 t 5 seconds. A more preferable time period is about 0.1 to 3 seconds.

The mixing devices shown in FIGS. 2 to 11 of Embodiment 1 can be suitably used as the first and second mixing devices 212 and 213 of Embodiment 2. The degassing devices shown in FIGS. 12 to 17 of Embodiment 1 can be suitably used as the degassing device 214. For this reason, the explanations of the mixing devices 212 and 213 and the degassing device 214 are omitted.

### EXAMPLE 2

The following is an example of Embodiment 2 of the present invention. Embodiment 2 is not limited to this example.

An operation was performed in high purity nitrogen gas as follows:

An alkene solution prepared by dissolving 4.0 g of aerosol OT (Wako Pure Chemical Industries, Ltd.) in 80 ml of decane (Wako Pure Chemical Industries, Ltd.) was added and mixed in a metallic salt solution prepared by dissolving 0.46 g of triammonium iron (III) trioxalate (Fe(NH4)₃(C₂O₄)₃) (Wako Pure Chemical Industries, Ltd.) and 0.46 g of potassium chloroplatinate (K₂PtCl₄) (Wako Pure Chemical Industries, Ltd.) in 24 μm of H₂O (deoxidized), so that a reserved micelle solution of the first solution L1 was prepared.

An alkene solution prepared by dissolving 5.4 g of aerosol OT in 40 ml of decane (Wako Pure Chemical Industries, Ltd.) was added and mixed in a reducer solution prepared by dissolving 0.50 g of NaBH₄ (Wako Pure Chemical Industries, Ltd.) in 12 ml of H₂O (deoxidized), so that a reserved micelle solution of the second solution L2 was prepared.

An alkene solution prepared by dissolving 3.5 g of aerosol OT (Wako Pure Chemical Industries, Ltd.) in 20 ml of decane (Wako Pure Chemical Industries, Ltd.) was added and mixed in a metallic salt solution prepared by dissolving 0.09 g of copper chloride (CuCl₂.6H₂O) (Wako Pure Chemical Industries, Ltd.) in 2 ml of H₂O (deoxidized), so that a reserved micelle solution of the third solution L3 was prepared.

An alkene solution prepared by dissolving 5.4 g of aerosol OT (Wako Pure Chemical Industries, Ltd.) and 2 ml of oleyl amine (Tokyo Kasei Kogyo Co., Ltd.) in 40 ml of decane (Wako Pure Chemical Industries, Ltd.) was added and mixed in a solution prepared by dissolving 0.88 g of ascorbic acid (Wako Pure Chemical Industries, Ltd.) and 0.33 g of a chelating agent (DHEG) in 12 ml of H₂O (deoxidized), so that a reserved micelle solution of the fourth solution L4 was prepared.

In the conventional method of manufacturing metal fine particles, the four reserved micelle solutions (L1, 2, 3, 4) were mixed in a tank in a batch manner as follows. While the reversed micelle solution (L1) was agitated with high speed at 22° C. by using an omnimixer (Yamato Scientific Co., Ltd.), the reversed micelle solution (L2) was added in a moment. After three minutes, the reversed micelle solution (L3) was added at a velocity of about 2.4 ml/minute for about ten minutes. Five minutes after the completion of the addition, the omnimixer was switched to a magnetic stirrer. After a temperature was raised to 40° C., the reversed micelle solution (L4) was added and aged for 120 minutes. Metal fine particles obtained thus will be referred to as a conventional sample.

In contrast to the conventional method, in the production unit 200 for a chemical substance of the present invention, the reversed micelle solution (L1) and the reversed micelle solution (L2) were instantly mixed using the first mixing device 212 shown in FIG. 18. The reaction liquid LM was extracted from the first mixing device 212 at the completion of mixing. The reaction liquid LM was fed to the second mixing device 213 of FIG. 18 after ten minutes while reaction by-product gas was removed by the degassing device 214 of vertically meandering flow method shown in FIG. 12. The reversed micelle solution (L3) was added to the second mixing device 213 and instantly mixed therein. Liquid from the second mixing device 213 is collected to the product tank 221. Five minutes after the reversed micelle solution (L3) was added, agitation was switched to slow agitation made by the agitating blade 221a. After a temperature was raised to 40° C., the reversed micelle solution (L4) was added and aged for 120 minutes. Metal fine particles obtained thus will be referred to as a sample of the present invention method.

The sample of the conventional method and the sample of the present invention method are cooled to room temperature. Thereafter, 2 ml of oleic acid (Wako Pure Chemical Industries, Ltd.) was added and mixed in the samples, and then the samples were extracted to the air. In order to destroy reversed micelles, a mixed solution of 200 ml of H₂O and 200 ml of methanol was added to the samples, and the samples were each divided into an aqueous phase and an oil phase. Metal nanoparticles were spread on the side of the oil phase. The side of the oil phase was cleaned five times with a mixed solution of 600 ml of H₂O and 200 ml of methanol. Thereafter, 1300 ml of methanol was added to cause flocculation on metal nanoparticles, and then the metal nanoparticles were settled. A supernatant fluid was removed and 20 ml of heptane (Wako Pure Chemical Industries, Ltd.) was added and the metal nanoparticles were dispersed again. Then, 100 ml of methanol was added to settle the metal nanoparticles. This processing was repeated twice. Finally, 5 ml of octane (Wako Pure Chemical Industries, Ltd.) was added, so that a solution of dispersed metal nanoparticles of multi-component alloys of FeCuPt was obtained. The metal nanoparticles include fine particles having a nano-grain size.

Regarding metal nanoparticles obtained by the conventional method and metal nanoparticles obtained by the present invention method, a yield, a composition, a volume average grain size, and a grain size distribution (coefficient of variation), and a coercive force were measured. A composition and a yield were measured by ICP spectrochemical analysis (inductively coupled plasma spectrometry). A volume, an average grain size, and a grain size distribution were obtained by measuring particles, which have been photographed by TEM, and performing statistical processing. A coercive force was measured using high-sensitivity magnetization vector measurement equipment (Toei Industry Co., Ltd.) and DATA processing equipment (Toei Industry Co., Ltd.) with an applied magnetic field of 790 kA/m (10 kOe). Metal nanoparticles for measurement were collected from a prepared fluid dispersion of metal panoparticles, sufficiently dried, and heated in an electric furnace for 30 minutes at 550° C. before measurement.

Table 2 shows measurement results on metal nanoparticles of the conventional method and metal nanoparticles of the present invention method.

TABLE 2

| | | Metal nanoparticles |
|---|---|---|
| | Metal nanoparticles of | of present |
| | conventional method | invention method |
| Yield | 65% | 85% |
| Composition | FeCuPt = 52/20/28 | FeCuPt = 42/16/42 |
| Volume average grain size | 5.3 nm | 5.1 nm |
| Grain size distribution | 15% | 5.3% |
| (coefficient of variation) | | |
| Coercive force | 450 kA/m | 510.2 kA/m |

As is understood from the results of Table 2, as compared with the metal nanoparticles of the conventional method, the metal nanoparticles of the present invention metal were smaller in size with high monodispersity. Further, as compared with the conventional method, the present invention method has a higher yield, a higher content of Pt in its composition, and a larger coercive force.

1. A reaction method for a reaction system generating gas by a reaction, comprising the steps of:
providing a sealed mixing section for mixing a plurality of liquids to start a reaction and a degassing section having a gas-liquid interface for removing, from a reaction liquid, gas bubbles generated from a mixed reaction liquid, separately; and
feeding the reaction liquid mixed in the mixing section to the degassing section.

2. The reaction method according to claim 1,
wherein mixing is instantly performed in the mixing section.

3. The reaction method according to claim 1,
wherein the degassing section is a path where the gas-liquid interface is formed by a liquid part of the reaction liquid and a space for storing gas removed from the reaction liquid, and gas bubbles in the reaction liquid passing through the path are removed to the space.

4. The reaction method according to claim 3,
wherein a pressure of the space is reduced.

5. The reaction method according to claim 3,
wherein the path has an upflow path and a downflow path where the reaction liquid continuously flows, and the gas-liquid interface is formed on a part where a flow is reversed from the upflow path to the downflow path.

6. The reaction method according to claims 3,
wherein the reaction liquid passes through the path where the upflow path and the downflow path are configured in multiple stages.

7. The reaction method according to claims 1,
wherein the reaction liquid passing through the degassing section is heated or cooled to control a reaction temperature.

8. The reaction method according to claims 1,
wherein ultrasonic waves are applied to the reaction liquid passing through the degassing section.

9. The reaction method according to claims 5,
wherein the reaction liquid passing through the downflow path has a lower flow velocity than an upflow velocity of the bubbles.

10. The reaction method according to claims 1,
wherein the degassing section is transparent.

11. A reaction apparatus for a reaction system generating gas by a reaction, comprising:
a sealed mixing section for mixing a plurality of liquids to start a reaction; and
a degassing section which is separated from the mixing section and has a gas-liquid interface for removing, from a reaction liquid, gas bubbles generated from the reaction liquid having been mixed in the mixing section.

12. The reaction apparatus according to claim 11,
wherein the mixing section is a high-pressure mixing device which supplies at least one of the plurality of liquids as a high-pressure jet flow of 1 MPa or more into a mixing chamber with a residence time of 5 seconds or less, and instantly mixes the liquid with another liquid.

13. The reaction apparatus according to claim 11, having the degassing section which is a path where the gas-liquid interface is formed by a liquid part of the reaction liquid and a space for storing gas removed from the reaction liquid, comprising:
the degassing section includes a degassing container having an inlet and an outlet for the reaction liquid;
a plurality of sheathing boards each of which is raised from a bottom of the degassing container and has an upper end positioned lower than the gas-liquid interface; and
a baffles each of which is disposed between the sheathing boards and has an upper end positioned higher than the gas-liquid interface and a lower end separated from the bottom of the degassing container,
wherein the degassing container has an upflow path and a downflow path where the reaction liquid continuously flows, and the gas-liquid interface is formed on a part where a flow is reversed from the upflow path to the downflow path in the degassing container.

14. The reaction apparatus according to claim 13,
wherein the space is not partitioned by the baffles.

15. The reaction apparatus according to claim 13,
wherein the sheathing boards become lower, one by one, from the inlet to the outlet of the degassing container.

16. The reaction apparatus according to claims 13,
wherein a pressure adjusting device for adjusting a pressure of the space is provided.

17. The reaction apparatus according to claim 11,
wherein the degassing section includes temperature adjusting device for heating or cooling the reaction liquid to control a reaction temperature.

18. The reaction apparatus according to claims 11,
wherein the degassing section includes ultrasonic wave applying device for applying ultrasonic waves to the reaction liquid.

19. The reaction apparatus according to claims 13,
wherein an agitator for forming a flow for preventing liquid from remaining is provided in a bottom of the upflow path formed in the degassing container.

20. The reaction apparatus according to claims 13,
wherein the downflow path is different in cross-sectional area from the upflow path.

21. The reaction apparatus according to claims 13,
wherein a surface treatment is performed on an inner surface of the degassing container, a surface of the sheathing board, and a surface of the baffle to reduce adhesion of the gas bubbles.

22. The reaction apparatus according to claims 13,
wherein the bottom of the degassing container is shaped like an arc where a flow of the reaction liquid is reversed from the downflow path to the upflow path.

23. The reaction apparatus according to claims 13,
wherein the reaction of the plurality of liquids is a reaction for generating magnetic particles.

24. A method of manufacturing a chemical substance generating gas in response to a reaction, comprising:
a first mixing step of performing a mixing reaction on a plurality of solutions in a sealed first mixing section;
a degassing step of performing degassing for gas bubbles in a degassing section having a gas-liquid interface, the gas bubbles being generated from a reaction liquid having been subjected to the mixing reaction in the first mixing step; and
a second mixing step of performing a mixing reaction by adding an added solution to the reaction liquid in a second mixing section, the reaction liquid having been subjected to degassing in the degassing step,
wherein the reaction liquid is fed from the first mixing step to the degassing step and then fed to the second mixing step after completion of degassing in the degassing step.

25. The method of manufacturing a chemical substance according to claim 24,
wherein mixing/degassing steps having the first mixing step and the degassing step as a combination is provided in series in a number of stage.

26. The method of manufacturing a chemical substance according to claim 24,
wherein a magnetic particles are manufactured as the chemical substance by mixing a first solution containing two or more kinds of metal ions selected from groups 8, 9, and 10 of a periodic table and a second solution containing a reducer in the first mixing step, and adding and mixing a third solution containing one or more kinds of metal ions selected from groups 11, 12, 13, 14, and 15 of the periodic table to a reaction liquid having been mixed in the first mixing step.

27. The method of manufacturing a chemical substance according to claims 24,
wherein of the first mixing step and the second mixing step, mixing is instantly performed at least in the first mixing step.

28. The method of manufacturing a chemical substance according to claims 24,
wherein the degassing section is a path where the gas-liquid interface is formed by a liquid part of the reaction liquid and a space for storing gas removed from the reaction liquid, and gas bubbles in the reaction liquid passing through the path are removed to the space.

29. The method of manufacturing a chemical substance according to claim 28, wherein a pressure of the space is reduced.

30. The method of manufacturing a chemical substance according to claim 28,
wherein the path has an upflow path and a downflow path where the reaction liquid continuously flows, and the gas-liquid interface is formed on a part where a flow is reversed from the upflow path to the downflow path.

31. The method of manufacturing a chemical substance according to claims 28,
wherein the reaction liquid passing through the degassing section is heated or cooled to control a reaction temperature.

32. The method of manufacturing a chemical substance according to claims 28,
wherein ultrasonic waves are applied to the reaction liquid passing through the degassing section.

33. The method of manufacturing a chemical substance according to claims 24,
wherein the reaction liquid passing through the downflow path has a lower flow velocity than the upflow velocity of the bubbles.

34. The method of manufacturing a chemical substance according to claims 24,
wherein the degassing section is transparent.

35. A manufacturing apparatus for a chemical substance generating gas in response to a reaction, the unit comprising:
a sealed first mixing section performing a mixing reaction on a plurality of solutions;
a second mixing section performing a mixing reaction by adding an additive solution to a reaction liquid having been mixed in the first mixing section; and
a degassing section having a gas-liquid interface for removing, from the reaction liquid, gas bubbles generated from the reaction liquid having been subjected to the mixing reaction in the first mixing section, which is provided between the first mixing section and the second mixing section.

36. The manufacturing apparatus for a chemical substance according to claim 35,
wherein of the first mixing section and the second mixing section, at least the first mixing section is a high-pressure mixing device which supplies at least one of the plurality of solutions as a high-pressure jet flow of 1 MPa or more into a mixing chamber with a residence time of 5 seconds or less, and instantly mixes the solution with another solution.

37. The manufacturing apparatus for a chemical substance according to claim 35,
wherein the degassing section is a path where the gas-liquid interface is formed by a liquid part of the reaction liquid and a space for storing gas removed from the reaction liquid,
wherein the degassing section comprises:
a degassing container having an inlet and an outlet for the reaction liquid;
a plurality of sheathing boards each of which is raised from a bottom of the degassing container and has an upper end positioned lower than the gas-liquid interface; and
a baffles each of which is disposed between the sheathing boards and has an upper end positioned higher than the gas-liquid interface and a lower end separated from the bottom of the degassing chamber,
wherein the degassing container has an upflow path and a downflow path where the reaction liquid continuously flows, and the gas-liquid interface is formed on a part where a flow is reversed from the upflow path to the downflow path in the degassing chamber.

38. The manufacturing apparatus for a chemical substance according to claim 37,
wherein the space is not partitioned by the baffles.

39. The manufacturing apparatus for a chemical substance according to claim 37,
wherein the sheathing boards become lower, one by one, from the inlet to the outlet of the degassing container.

40. The manufacturing apparatus for a chemical substance according to claims 37, further comprising:
a pressure adjusting device for adjusting a pressure of the space.

41. The manufacturing apparatus for a chemical substance according to claims 35,
wherein the degassing section comprises a temperature adjusting device for heating or cooling the reaction liquid to control a reaction temperature.

42. The manufacturing apparatus for a chemical substance according to claims 35,
wherein the degassing section further comprises a ultrasonic wave applying device for applying ultrasonic waves to the reaction liquid.

43. The manufacturing apparatus for a chemical substance according to claims 37,
wherein an agitator for forming a flow for preventing liquid from remaining is provided in a bottom of the upflow path formed in the degassing container.

44. The manufacturing apparatus for a chemical substance according to claims 37,
wherein the downflow path is different in cross-sectional area from the upflow path.

45. The manufacturing apparatus for a chemical substance according to claims 37,
wherein a surface treatment is performed on an inner surface of the degassing container, a surface of the sheathing board, and a surface of the baffle to reduce adhesion of the gas bubbles.

46. The manufacturing apparatus for a chemical substance according to claims 37,
wherein the bottom of the degassing container is shaped like an arc where a flow of the reaction liquid is reversed from the downflow path to the upflow path.

47. A magnetic particle manufactured using the method of manufacturing a chemical substance according to claims 24.

48. A magnetic particle manufactured using the manufacturing apparatus for a chemical substance according to claims 35.

49. A magnetic recording medium,
wherein the magnetic particle according to claim 47 is contained in a magnetic layer.
